(19) United States
(12) Patent Application Publication
(10) Pub. No.: US 2025/0196265 A1
(43) Pub. Date: Jun. 19, 2025

(54) LASER CLADDING REPAIR METHOD AND APPARATUS FOR SURFACE DAMAGE OF PART, AND PART

(71) Applicant: CRRC QINGDAO SIFANG CO., LTD., Shandong (CN)

(72) Inventors: Xiaohui HAN, Shandong (CN); Lei XU, Shandong (CN); Zhiyi ZHANG, Shandong (CN); Yongshou WU, Shandong (CN); Xifeng FANG, Shandong (CN); Gangqing LI, Shandong (CN); Jinshan CAO, Shandong (CN); Yin MA, Shandong (CN); Yihui GUAN, Shandong (CN)

(21) Appl. No.: 18/984,441

(22) Filed: Dec. 17, 2024

(30) Foreign Application Priority Data
Dec. 19, 2023 (CN) 202311752507.8

(51) Int. Cl. B23K 26/342

(52) U.S. Cl. CPC B23K 26/342

(57) ABSTRACT

The present application relates to the field of remanufacturing, particularly to a laser cladding repair method and apparatus for surface damage of part, and a part. The laser cladding repair method for surface damage of part includes: preparing a cladding material for repair, and preparing a groove based on a defect characteristic of a to-be-repaired part obtained from inspection and assessment; performing procedure optimization and procedure qualification; performing, based on a result of the procedure optimization and the procedure qualification, laser cladding repair procedure on a defect location to form a cladding layer on the groove; and performing quality evaluation on the cladding layer. This method may be used for surface repair of damaged surfaces of parts during service, achieving dimensional recovery, performance maintenance, and repeatedly installing and using parts, to solve the practical problems of traditional “replacement instead of repair”.

### CROSS REFERENCE TO RELATED APPLICATIONS

The present application claims priority to and the benefit of co-pending Chinese Patent Application No. 202311752507.8 filed on Dec. 19, 2023, titled “Laser Cladding Repair Method and Apparatus for Surface Damage of Part, and Part”, which is hereby incorporated by reference in its entirety.

### FIELD

The present application relates to the field of remanufacturing, in particular to a laser cladding repair method and apparatus for surface damage of part, and a part.

### BACKGROUND

Parts of a device are prone to fretting wear at contact interfaces due to mutual contact or bearing load during operation of the device. Complex and harsh service environments may lead to crevice corrosion, affecting the precise fit with parts and posing significant safety hazards to operation of the device. A traditional thermal processing repair method for repairing damaged surfaces commonly used in the related art may easily cause microstructure damage to the repaired surface due to the large heat input of thermal processing, resulting in decreased performance of the repaired part. Moreover, the traditional thermal processing repair method may easily cause deformation of the repaired surface during the process of repairing parts of a device, and the repaired part is unusable due to out-of-tolerance size. Therefore, there is no effective repair method for the damage to parts of the device during service in the industry, and the “replacement instead of repair” method is usually adopted to ensure the safe operation of device.

Therefore, it is urgent to study a repair method for surface damage of part that may reuse the part and to develop a repair method with advantages of small damage to a substrate, good bonding performance between a cladding layer and the substrate, small repair deformation, and high precision.

### SUMMARY

The present application provides a laser cladding repair method for surface damage of part, to solve a defect that there is currently no effective repair method for damage to parts of a device in the industry during service, and “replacement instead of repair” is usually adopted to ensure the safe operation of device. The method achieves effects of small damage to the substrate, good bonding performance between the cladding layer and the substrate, small repair deformation, and high precision during the repair process.

The present application further provides a laser cladding apparatus for surface damage of part.

The present application further provides a part repaired by laser cladding.

The present application provides a laser cladding repair method for surface damage of part, including:
preparing a cladding material for repair, and preparing a groove based on a defect characteristic of a to-be-repaired part obtained from inspection and assessment;
performing procedure optimization and procedure qualification;
performing, based on a result of the procedure optimization and the procedure qualification, laser cladding repair procedure on a defect location to form a cladding layer at the groove; and
performing quality evaluation on the cladding layer.

According to the laser cladding repair method for surface damage of part provided by the present application, in the result of the procedure optimization and the procedure qualification, a procedure parameter of the laser cladding repair procedure includes: a spot diameter of a laser thermal source is greater than or equal to 3 millimeters and less than or equal to 6 millimeters.

According to the laser cladding repair method for surface damage of part provided by the present application, preparing the cladding material for repair includes:
selecting powder preliminarily to produce the cladding material, where the selecting powder preliminarily is based on a principle of processability and an approximation principle of physical properties,
the principle of processability includes: investigating self-solubility, wettability, and crack resistance of to-be-selected powder; and
the approximation principle of physical properties includes: investigating that a coefficient of thermal expansion and a melting point of the to-be-selected powder approximate to a coefficient of thermal expansion and a melting point of a substrate.

According to the laser cladding repair method for surface damage of part provided by the present application, preparing the groove based on the defect characteristic of the to-be-repaired part obtained from inspection and assessment includes:
determining the defect characteristic of the to-be-repaired part;
determining groove forms and a processing parameter for the groove based on the defect characteristic; and
preparing the groove based on the processing parameter.

According to the laser cladding repair method for surface damage of part provided by the present application, determining the defect characteristic of the to-be-repaired part further includes:
pre-building a three-dimensional model of a part as a standard reference group;
inspecting and obtaining a scanning model of the to-be-repaired part; and
comparing the scanning model with the standard reference group to obtain the defect characteristic of the defect location of the to-be-repaired part.

According to the laser cladding repair method for surface damage of part provided by the present application, the defect characteristics include defect types and a defect size, where
the defect types include a point defect, a scratch defect, a curved surface defect, a flat surface defect, and a part edge defect; and
the groove forms include a point cladding groove, a line cladding groove, a curved surface cladding groove, a flat surface cladding groove, and a part edge groove.

According to the laser cladding repair method for surface damage of part provided by the present application, performing the procedure optimization and the procedure qualification includes:
building, based on the defect characteristic and performance of the cladding material, a repair procedure parameter model to perform the procedure optimization and sample preparation;
performing corresponding qualification tests on various types of cladding samples obtained from the sample preparation to obtain a result of the procedure qualification;
providing feedback and modifying the procedure optimization based on the result of the procedure qualification, where
the procedure optimization includes determining an optimal procedure parameter based on the procedure parameter of the repair procedure parameter model during laser cladding repair, through an orthogonal coupling experiment in combination with a range analysis;
the procedure parameters of the repair procedure parameter model include laser power, a scanning speed, a powder feeding rate, and a diameter of a laser spot; and
the qualification test includes macroscopic observation and microstructure observation, as well as fretting friction wear test, and investigating a dilution rate of the cladding layer of the cladding sample.

According to the laser cladding repair method for surface damage of part provided by the present application, building, based on the defect characteristic and performance of the cladding material, the repair procedure parameter model includes:
determining to-be-repaired morphology parameters of the to-be-repaired part based on the defect characteristic, and building the repair procedure parameter model, where the to-be-repaired morphology parameters include a cladding width, a cladding height, and a dilution rate; and
setting the procedure parameter for the laser cladding repair procedure based on the repair procedure parameter model and the to-be-repaired morphology parameters.

According to the laser cladding repair method for surface damage of part provided by the present application, determining the to-be-repaired morphology parameters of the to-be-repaired part based on the defect characteristic, and building the repair procedure parameter model includes:
selecting, in sequence, one of the procedure parameters of the laser cladding repair procedure as an only test variable parameter, and performing a single-pass cladding layer single-factor test;
obtaining a set of cladding quality parameters for a single-pass cladding layer, where the cladding quality parameters include the cladding width, the cladding height, and the dilution rate; and
building the repair procedure parameter model based on the set of cladding quality parameters.

According to the laser cladding repair method for surface damage of part provided by the present application, the repair procedure parameter model is:

$$D = 0.8 \times {X}^{- 2} \times {K}^{1.8} + 0.9 \times ( 3.5 - R ) ,$$

$$H = 0.4 \times ( {X}^{- 0.9} ) \times {K}^{0.4} + 0.2 \times ( 3.5 - R ) , and$$

$$W = 2.2 \times ( {X}^{- 0.5} ) \times {K}^{0.4} - 0.4 \times ( 3.5 - R ) ,$$

where

D is the dilution rate; H is the cladding height; W is the cladding width; X is a powder feeding rate; K is a laser energy density, K=P/V, P is the laser power, and V is the scanning speed; and R is the diameter of the laser spot.

According to the laser cladding repair method for surface damage of part provided by the present application, the qualification tests further include at least one of hardness test, tensile test, impact test, corrosion resistance test, micro shear test, bending performance test, and fatigue test.

According to the laser cladding repair method for surface damage of part provided by the present application, before preparing the groove, the laser cladding repair method for surface damage of part further includes removing defect; and/or,
before the qualification test, and/or after performing the laser cladding repair procedure, the laser cladding repair method for surface damage of part further includes non-destructive testing, where the non-destructive testing includes penetrant testing and X-ray testing.

According to the laser cladding repair method for surface damage of part provided by the present application, performing, based on the result of the procedure optimization and the procedure qualification, laser cladding repair procedure at the defect location to form the cladding layer on the groove includes:
making, based on the result of the procedure optimization and the procedure qualification, a laser cladding procedure regulation for the part, and determining optimal procedure parameters for the laser cladding repair procedure; and
performing laser cladding repair on the groove using the optimal procedure parameters based on the laser cladding procedure regulation and the cladding parameter corresponding to the defect characteristic.

According to the laser cladding repair method for surface damage of part provided by the present application, the optimal procedure parameters include that: the laser power ranges from 2000 watts to 3000 watts, the diameter of the laser spot is 4 millimeters to 6 millimeters, a nozzle distance is 8 millimeters to 12 millimeters, the scanning speed is 6 millimeters/second to 10 millimeters/second, the powder feeding rate is 5 grams/minute to 12 grams/minute, a powder feeding gas flow rate is 6 liters/minute to 8 liters/minute, a protective gas flow rate is 30 liters/minute to 40 liters/minute, and an overlap rate is 40% to 50%.

According to the laser cladding repair method for surface damage of part provided by the present application, after performing laser cladding repair on the groove, the laser cladding repair method further includes cladding layer inspection and stress relief treatment, where
the cladding layer inspection includes:
selecting several detection positions at the cladding layer for subtractive processing, where the substrate being not exposed at the subtractive-processed detection position is taken as being qualified,
where an amount of subtractive processing at the detection position is not less than 0.5 millimeters; and
the stress relief treatment includes:
performing stress relief on the repaired cladding layer through ultrasonic vibration impact, where
a residual stress of the stress-relieved cladding layer is not higher than 159 megapascals.

According to the laser cladding repair method for surface damage of part provided by the present application, performing quality evaluation on the cladding layer further includes:
performing quality evaluation on the cladding layer based on operating environment and working condition of the part after performing laser cladding repair procedure on the defect location, where
items of the quality evaluation include surface inspection, at least two non-destructive tests, dimensional check, processing inspection, fatigue test, and trial operation investigation.

According to the laser cladding repair method for surface damage of part provided by the present application, the laser cladding repair method for surface damage of part further includes
performing post-processing on the part, where
performing post-processing on the part includes:
machining a part passing the quality evaluation based on a requirement for part usage;
performing pre-installation inspection on the machined part;
if the pre-installation inspection passes, performing installing and trial usage and completing quality inspection of the part; and
if the pre-installation inspection fails, scrapping the part.

The present application further provides a laser cladding apparatus for surface damage of part, which may perform the laser cladding repair method for surface damage of part as described above, where
the laser cladding apparatus for surface damage of the part includes a cladding material preparation system, a groove preparation system, a procedure optimization and qualification system, a laser cladding repair system, and a quality evaluation system connected to each other, where
the cladding material preparation system is used for preparing a cladding material for repair;
the groove preparation system is used for preparing a groove;
the procedure optimization and qualification system is used for performing procedure optimization and procedure qualification;
the laser cladding repair system is used for performing laser cladding repair procedure at the defect location; and
the quality evaluation system is used for performing quality evaluation on the cladding layer.

The present application further provides a part repaired by laser cladding, where the part is obtained by performing the laser cladding repair method for surface damage of part as described above; or, the part may be generated using the laser cladding apparatus for surface damage of part as described above;
the surface damage location of the part is filled with at least one cladding layer, and each cladding layer is at least partially overlapped with a previous cladding layer; each cladding pass within the same cladding layer at least partially overlaps with a previous cladding pass.

The present application provides a laser cladding repair method for surface damage of part, including: preparing a cladding material for repair, and preparing a groove based on a defect characteristic of a to-be-repaired part obtained from inspection and assessment; performing procedure optimization and procedure qualification; performing, based on a result of the procedure optimization and the procedure qualification, laser cladding repair procedure on a defect location to form a cladding layer on the groove; and performing quality evaluation on the cladding layer. This method is mainly used for repairing surface defects such as indentation and rust on the surface of parts, such as the repair of surface defects such as indentation and rust on the cast steel axle box body of high-speed trains made of G20Mn5 QT. This repair method may be used for surface repair of damaged surfaces of axle box bodies and other parts during service, and full process development and quality control may be carried out to ensure that the bonding strength, wear and corrosion resistance of the repaired layer are basically consistent with the substrate, achieving size recovery and performance maintenance of axle box bodies and other parts for recycle usage through axle box body repair, to solve the practical and traditional problem of traditional “replacement instead of repair”. Moreover, this repair method may simultaneously improve the service performance of parts such as wear resistance, corrosion resistance, impact resistance, and fatigue resistance through surface repair, prolong the service life of parts such as axle box bodies, and reduce device maintenance costs.

In the step of preparing the cladding material for repair described in this repair method, heterogeneous powder completely different from the composition and characteristics of the substrate may be selected based on the service conditions and repair characteristics of the parts, to mainly repair defects such as indentation and corrosion of cast steel axle box body parts made of G20Mn5 QT, which breaks through the bottleneck problems of part burning and performance degradation caused by traditional laser cladding, effectively improves the wear resistance, corrosion resistance, and fatigue resistance of the damaged surface of the cast steel axle box body, changes the current situation of “replacement instead of repair”, reduces the maintenance costs of high-speed trains, and improves the usage efficiency of the cast steel axle box body parts made of G20Mn5 QT.

In the step of preparing the groove based on the defect characteristic of the to-be-repaired part obtained from inspection and assessment described in this repair method, standardized and normalized groove is designed by determining the groove forms and processing parameter for the defect characteristics in a targeted manner, ensuring the consistency and stability of laser cladding quality. By reasonably matching the cladding parameters and accurately cladding, the cladding quality of the laser cladding repaired layer has been improved, and the cast steel axle box body is repaired in both high precision and high quality. By the step of performing procedure optimization and procedure qualification, as well as the step of performing quality evaluation on the cladding layer described in this repair method, the performance indicators of the cladding layer may be evaluated at the lowest cost during the preparation stage of the process sample, to provide feedback and correct the procedure optimization, achieve strong support and benign closed-loop control for the development of laser cladding process, and effectively solve the problem of scrapped train parts due to corrosion and wear that cannot be repaired, reduce the repair cost of carbon steel parts, and prolong the service life of parts.

The step of performing, based on the result of the procedure optimization and the procedure qualification, laser cladding repair procedure on the defect location to form the cladding layer on the groove may build a laser cladding procedure parameter calculation model, which may set laser cladding procedure parameter at low cost and quickly, improve parameter accuracy, ensure laser cladding quality, and improve laser cladding efficiency.

The laser cladding repair method for surface damage of part described in the present application is applied to the repair of cast steel axle box bodies. Compared with traditional laser cladding repair technologies, the advantages of the present application are as follows.

1. After test and research, the laser cladding repair method for surface damage of part described in the present application may form a set of laser cladding repair procedure, methods, and evaluation standards for three-dimensional thin-walled complex structural parts such as cast steel axle box bodies. It overcomes the problem of traditional laser cladding process being unsuitable for complex structures and solves the problem of the damaged surface of the axle box body being unable to be repaired due to high carbon equivalent of the substrate, easy deformation of the repair surface, and strict service requirements.

2. For the first time, a high-energy laser with the diameter of the laser spot of 3-6 mm has been used as a heat source for repairing defect in precision assembly parts of axle box bodies of a high-speed train. It has the characteristics of high precision, good controllability, low dilution rate, good interface bonding, high degree of automation, and stable and reliable quality. It is suitable for surface repair and modification of hole parts, curved parts, and flat parts.

3. The cladding material in the present invention is prepared from spherical powder made of stainless steel alloy and rare earth elements and a cladding coating is obtained by a specific laser cladding process. The tensile, bending, hardness, impact, fatigue, corrosion resistance and other performance indicators of the cladding coating are not significantly different from those of the axle box body substrate. The difference in performance indicators between the repaired layer and the substrate is controlled within +10%. The stainless steel and cast steel axle box body are metallurgically bonded by heterogeneous materials, and all performance indicators meet the service requirements.

4. The cast steel axle box body is a complex structural part with a three-dimensional thin-walled structure and an inner cavity. It is prone to irregular deformation when heated and cannot be corrected. However, this method may be applied to the repair of point, line, and surface defect in complex structures. Combined with the repair apparatus, it may effectively control deformation and achieve collaborative control with laser cladding robots to complete spatial repair. It may effectively prevent deformation of the axle box body due to thermal expansion and contraction after laser heating. Through collaborative displacement control, the laser may accurately point to the defect area and achieve precise cladding.

5. A coupling control method for procedure parameter such as laser power, the diameter of the laser spot, powder feeding rate, cladding sequence, cladding amount, and overlapping amount of the cladding layer is developed, which ensures both deformation control and effective cladding of the cladding interface, thereby ensuring the quality of the cladding.

6. By performing a series of tests and evaluations such as tensile, shear, bending, impact, fatigue, corrosion, and fretting wear on the repair layer, performance evaluation, procedure qualification, and quality evaluation are performed on the repaired area, which effectively supports the reliability of the entire laser cladding repair method.

7. By performing long-life cycle vibration fatigue and fretting wear test on the repaired axle box body under simulated train service conditions, the service performance of the welded repaired axle box body after being loaded may be determined, which supports the installing verification of the repaired axle box body.

The present application further provides a laser cladding apparatus for surface damage of part, which may perform the laser cladding repair method for surface damage of part as described above. The laser cladding apparatus for surface damage of the part includes the cladding material preparation system, the groove preparation system, the procedure optimization and qualification system, the laser cladding repair system, and the quality evaluation system which are connecter to each other, where the cladding material preparation system is used for preparing a cladding material for repair; the groove preparation system is used for preparing a groove; the procedure optimization and qualification system is used for performing procedure optimization and procedure qualification; the laser cladding repair system is used for performing laser cladding repair procedure at the defect location; and the quality evaluation system is used for performing quality evaluation on the cladding layer. By providing the above-mentioned cladding material preparation system, the groove preparation system, the procedure optimization and qualification system, the laser cladding repair system, and quality evaluation system, and the repair apparatus may correspondingly have all the advantages of the laser cladding repair method for surface damage of part mentioned above, which will not be further elaborated here.

The present application further provides a part repaired by laser cladding, where the part is obtained by performing the laser cladding repair method for surface damage of part as described above; or, the part may be generated using the laser cladding apparatus for surface damage of part as described above; the surface damage location of the part is filled with at least one cladding layer, and each cladding layer is at least partially overlapped with a previous cladding layer; each cladding pass within the same layer of cladding layer at least partially overlaps with the previous cladding pass. The parts repaired by the above method or apparatus have good metallurgical bonding between the repaired cladding layer and the substrate, with small deformation and high repair accuracy. This may improve the dimensional recovery of the repaired parts compared to the original undamaged parts, which is beneficial for improving the assembly accuracy of subsequent parts, repeatedly installing and using the axle box body in service, prolonging the service life of parts such as the axle box body, and reducing device maintenance costs.

### BRIEF DESCRIPTION OF THE DRAWINGS

To illustrate the solutions of the embodiments of the present application more clearly, the accompanying drawings used in the description of the embodiments are briefly introduced below. It should be noted that the drawings in the following description are only some embodiments of the present application. For those skilled in the art, other drawings may be obtained based on these drawings without creative effort.

FIG. 1 is a schematic flowchart of a laser cladding repair method for surface damage of part according to the present application;

FIG. 2 is a specific flowchart of a laser cladding repair method for surface damage of part according to the present application;

FIG. 3 is a specific flowchart of steps for performing procedure optimization and procedure qualification according to the present application;

FIG. 4 is a top view of a sampling area of a surface defect according to the present application;

FIG. 5 is a schematic structural diagram of a single-layer cladding layer of a part repaired by laser cladding according to the present application;

FIG. 6 is a schematic structural diagram of a double-layer cladding layer of a part repaired by laser cladding according to the present application; and

FIG. 7 is a metallographic structural diagram of a part repaired by laser cladding according to the present application.

### REFERENCE SIGNS

1: substrate;
2: cladding layer;
31: first sampling area; 32: second sampling area; 33: third sampling area; 34: fourth sampling area; 35: fifth sampling area; 36: sixth sampling area.

### DETAILED DESCRIPTION

To clarify the objectives, solution, and advantages of the present application, the solution of the present application will be described clearly and completely in conjunction with the accompanying drawings. The described embodiments are a part of the embodiments of the present application, not all of them. Based on the embodiments of the present application, all other embodiments obtained by those skilled in the art without creative labor are within the scope of protection of the present application.

The axle box body of high-speed trains belongs to a key part under the spring of high-speed trains, which is a key part that connects the wheelset and bogie. The quality and status of the axle box body have significant impacts on the long-term service reliability and safety of the train. During the operation of the train, the vehicle is subjected to the impact load of alternating dynamic loads, and the contact interface between the axle box and other parts is prone to fretting wear. Due to the complex and harsh service environment, it is easy to cause crevice corrosion, which affects its precise fit with the axle and poses a significant safety hazard to the operation of high-speed trains. If traditional thermal processing methods are used to repair damaged surfaces, it is easy to cause microstructure damage and performance degradation due to large heat input. The axle box body is a three-dimensional thin-walled complex structure, and traditional thermal processing repair is prone to deformation during thermal processing, resulting in dimensional deviations and unable to use. There is currently no effective repair method for the damage caused to the axle box body during service in the industry, and replacement instead of repair is usually adopted to ensure the safety of train operation.

The axle box body is a three-dimensional thin-walled complex structure, and traditional thermal processing repair is prone to deformation during thermal processing, and the axle box body is unusable due to out-of-tolerance size. Laser cladding technology refers to the process of placing selected cladding materials on the surface of the repaired workpiece, and after laser irradiation, cladding a thin layer of cladding material and workpiece surface simultaneously, and rapidly solidifying to form a surface coating with extremely low dilution and metallurgical bonding with the workpiece substrate material, thereby significantly improving the wear resistance, corrosion resistance, heat resistance, oxidation resistance, and electrical properties of the substrate material surface. It is widely used in the surface repair of structural parts in rail transit. For example, laser cladding technology may be used to repair the axle box body of high-speed trains.

The laser cladding repair method for surface damage of part described in the embodiments of the present application (referred to as the “repair method” in this embodiment) may accurately and reliably repair the damaged surface of the cast steel axle box body by laser cladding, to achieve the repeatedly installing and using the axle box body in service. This repair method comprehensively analyzes the working conditions and material characteristics of the cast steel axle box body, and develops a repair process with small damage to the substrate, good bonding performance between the repair layer and the substrate, small repair deformation, and high precision.

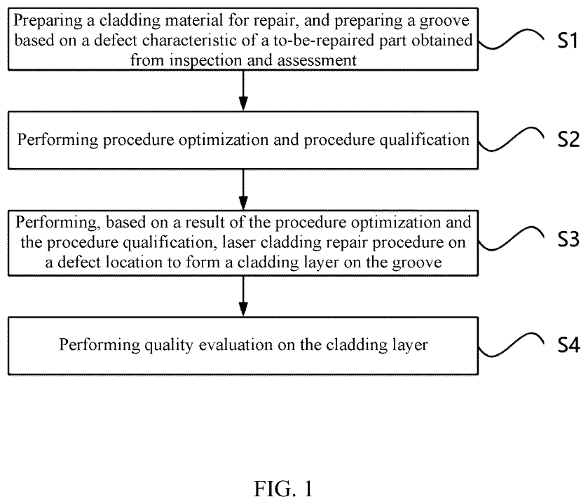

The laser cladding repair method for surface damage of part and the laser cladding apparatus for surface damage of part (referred to as the “repair apparatus” in this embodiment) of the present application will be described below with reference to FIG. 1-FIG. 7

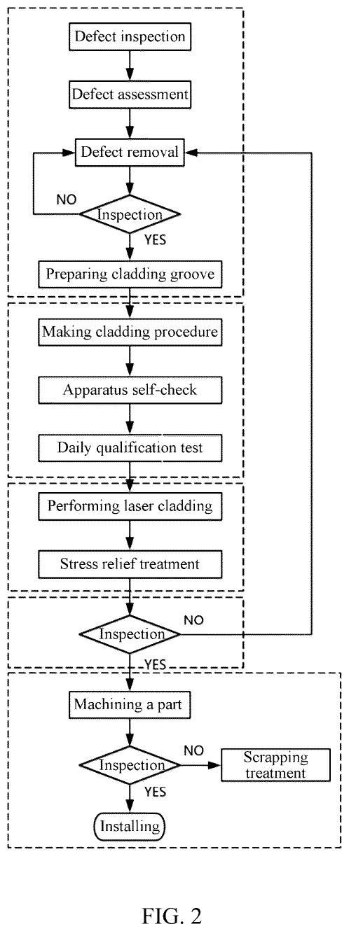

As shown in FIG. 1 and FIG. 2, the repair method provided by the present application includes:
S1: preparing a cladding material for repair, and preparing a groove based on a defect characteristic of a to-be-repaired part obtained from inspection and assessment;
S2: performing procedure optimization and procedure qualification;
S3: performing, based on a result of the procedure optimization and the procedure qualification, laser cladding repair procedure on a defect location to form a cladding layer on the groove; and
S4: performing quality evaluation on the cladding layer.

This method is mainly used for repairing surface defects such as indentation and rust corrosion on the surface of parts, such as the repair of surface defects such as indentation and rust corrosion on the cast steel axle box body of high-speed trains made of G20Mn5 QT. This method may be used for surface repair of damaged surfaces of parts during service, achieving dimensional recovery, performance maintenance, and repeatedly installing and using parts, to solve the practical problems of traditional “replacement instead of repair”. Moreover, this method may synchronously improve the service performance of parts such as wear resistance, corrosion resistance, impact resistance, and fatigue resistance through surface repair, prolong the service life of parts such as axle box bodies, and reduce device maintenance costs.

In the step S1 of preparing the cladding material for repair described in this repair method, heterogeneous powder that are completely different from the composition and characteristics of the substrate may be selected based on the service conditions and repair characteristics of the parts, to mainly repair defects such as indentation and corrosion of cast steel axle box body parts made of the G20Mn5 QT, which breaks through the bottleneck problems of part burning and performance degradation caused by traditional laser cladding, effectively improves the wear resistance, corrosion resistance, and fatigue resistance of the damaged surface of the cast steel axle box body, changes the current situation of “replacement instead of repair”, reduces the maintenance costs of high-speed trains, and improves the usage efficiency of the use of cast steel axle box body parts made of the G20Mn5 QT.

In the embodiments of the present application, the step S1 of preparing the cladding material for repair as described above further includes:
S111: selecting powder preliminarily to produce the cladding material.

In an embodiment, selecting powder preliminarily is based on a principle of processability and an approximation principle of physical properties.

In an embodiment, the principle of processability includes: investigating self-solubility, wettability, and crack resistance of to-be-selected powder (cladding material).

In an embodiment, the approximation principle of physical properties includes: investigating a coefficient of thermal expansion and a melting point of the to-be-selected powder (cladding material) approximate to a coefficient of thermal expansion and a melting point of a substrate.

In the embodiments of the present application, the preferred properties of the cladding material selected through step S111 are as follows: flowability of the powder is 15-20 s/50 g, loose density is 3-5 g/cm³, a particle size ranges 40-105 um, and the coefficient of thermal expansion approximates to and slightly lower than that of the substrate.

Preferably, the powder also has good wettability.

Preferably, the dilution rate of the powder is less than 5%; through macroscopic metallographic analysis of the sample, the bonding interface cladding will be good when the dilution rate of the powder does not exceed 5%.

In an embodiment, the powder includes one or a combination of iron-based alloy powder, nickel-based alloy powder, stainless steel powder, and mold steel powder.

In the embodiments of the present application, the selection principles of the preferred cladding material are as follows:
a principle that properties of the powder are compatible with, but not identical to the physical, metallurgical, and mechanical properties of the substrate;
a principle of fully considering important parameters such as powder flowability, coefficient of thermal expansion, wettability, and processability;
a principle that a cladding layer formed by the selected powder should have wear resistance, corrosion resistance, and toughness;
a principle that the cladding powder has a smaller particle size and a higher melting point, ensuring strong bonding with the substrate and a dilution rate of less than 5%; and
a principle of powder selected from iron-based alloy powder, nickel-based alloy powder, stainless steel powder and mold steel powder as cladding powder.

Powder screening is performed by controlling the dilution rate at a lower level.

Powder screening is performed by performing fatigue test on the cladding samples.

Powder screening is performed by performing corrosion experiment to the cladding samples.

The properties of the cladding material selected based on the above powder selection principles are as follows.

The properties of the powder itself: the powder has flowability of 15-20 s/50 g, loose density of 4 g/cm³, a particle size range of 40-105 um, a coefficient of thermal expansion similar to and slightly smaller than that of the substrate, and good wettability.

The powder cladding performance: the metallographic structure of the cladding layer has no defect, and its tensile, bending, impact, and hardness properties are equivalent to those of the substrate material.

The service performance of the powder: 10⁷ fatigue performance is not be lower than that of the substrate, the 100-hour salt spray corrosion resistance is not lower than that of the substrate, and the wear performance is similar to that of the substrate.

The powder selected through the above powder selection process as the cladding material may provide the best cladding layer performance under the same procedure parameter, while the cladding layer has excellent wear resistance, corrosion resistance, impact toughness, fatigue resistance and other properties.

In the embodiments of the present application, the step S1 of preparing a groove based on a defect characteristic of a to-be-repaired part obtained from inspection and assessment further includes:
S121: determining the defect characteristic of the to-be-repaired part;
S122: determining groove forms and a processing parameter for the groove based on the defect characteristic; and
S123: preparing the groove based on the processing parameter.

In the step of preparing the groove based on the defect characteristic of the to-be-repaired part obtained from inspection and assessment described in this repair method, standardized and normalized groove is designed by determining the groove form and processing parameter for the defect characteristics in a targeted manner, ensuring the consistency and stability of laser cladding quality. By reasonably matching the cladding parameters and accurately cladding, the cladding quality of the laser cladding repaired layer has been improved, and of the cast steel axle box body is repaired in both high precision and high quality. In the embodiments of the present application, by determining the groove form and processing parameter of the groove in a targeted manner based on the defect characteristic, standardized and normalized groove is designed, which ensures the consistency and stability of laser cladding quality. By reasonably matching the cladding parameters and accurately cladding, the cladding quality of the laser cladding repaired layer has been improved, and the cast steel axle box body is repaired in both high precision and high quality.

In an embodiment, in step S121, the defect characteristic of the to-be-repaired part is determined. This step may be achieved through observation, measurement, or scanning and building a simulation model, and this embodiment does not make specific limitations on this. For example, given that the corrosion location, defect type, and area size of the product are not fixed, a comprehensive scan of the defect may be performed using a 3Dsystems scanner. The obtained defect characteristics include a defect type and a defect size. Based on the size and morphology of the defect, the defect type may be classified into the point defect, the scratch defect, the curved surface defect, the flat surface defect, and the part edge defect.

In the embodiments of the present application, in step S121, the defect characteristic of the to-be-repaired part is determined. The step S121 further includes:
S121-1: pre-building a three-dimensional model of a part as a standard reference group;
S121-2: inspecting and obtaining a scanning model of the to-be-repaired part; and
S121-3: comparing the scanning model with the standard reference group to obtain the defect characteristic of the defect location of the to-be-repaired part.

The repair method of this embodiment provides defect inspection steps. In an embodiment, software Geomagic X is used to build a three-dimensional model for the unrepaired member (i.e., a part), as a standard reference group for deformation measurement; then a 3Dsystems scanner is used to scan and measure the laser-cladded part, and obtain a scanning model. Both the three-dimensional model and the scanning model are substituted into the analysis software, and the scanning model and the built three-dimensional model are compared and analyzed using a four-corner alignment method. The area, depth, width, scratches and other defect characteristics of the damaged axle box body may be effectively inspected by using a 3Dsystems scanner to build a three-dimensional model of the axle box body, setting size limits for each part, inspecting the size of each part, and marking and identifying the parts that exceed the size limit.

The repair method of this embodiment provides a defect assessment step. In an embodiment, based on the maintenance regulations for high-speed trains, the depth of longitudinal abrasions or scratches on the machined surface of the axle box body of the high-speed train shall not exceed 0.5 mm, the depth of local rust corrosion (or wear) shall not exceed 0.2 mm, and the depth of local rust corrosion on the two end surfaces of the axle box body (in contact with the front and rear covers) shall not exceed 1.5 mm. The defects are analyzed and assessed based on the detection result, and the defects are classified into at least point defect, line defect, and surface defect based on the shape, type, and size of points, lines, and surfaces. Software designed data models are used for classification and grading the defects.

In this embodiment, the repair method further includes defect removal before the step of preparing the groove. Defects may be removed through machining or polishing. Defect removal is a pre-treatment process of laser cladding. In practical operation, considering the effect of the edge position of the damaged surface defect removal on the quality of laser cladding, non-destructive testing, for example, magnetic particle testing (MT) may be used to determine whether the defect is completely removed after defect removal treatment.

In this embodiment, in step S122, i.e., determining groove forms and a processing parameter for the groove based on the defect characteristic includes determining the groove forms and processing parameter and cladding parameters for the groove based on the defect characteristic. Defect characteristics include a defect type and a defect size. The defect types include at least a point defect, a line defect (i.e., scratch defect), a surface defect (such as a curved surface defect and a flat surface defect), and a part edge defect; correspondingly, groove forms include a point cladding groove, a line cladding groove, a curved surface cladding groove, a flat surface cladding groove, and a part edge groove.

In this embodiment, there is a mapping relationship between defect characteristics and groove forms and defect characteristics are in one-to-one correspondence with groove forms. In an embodiment, the corresponding groove form may be determined based on the defect type in the defect characteristic. For example, the groove form corresponding to point defect is a point cladding groove; the groove form corresponding to scratch defect is a line cladding groove; the groove form corresponding to the curved surface defect is a curved surface cladding groove; the groove form corresponding to the flat surface defect is a plane cladding groove; and the groove form corresponding to the part edge defect is the part edge groove.

The processing parameter and cladding parameter for the groove are associated with the groove form and the defect size. This section will be explained in detail below. By determining the groove form and determining the processing parameter of the groove for the defect characteristic, standardized and normalized groove is designed, which ensures the consistency and stability of laser cladding quality.

In this embodiment, in step S123, the groove is prepared based on the processing parameter. The preferred method further includes a step of repairing the groove based on the cladding parameter. The repair steps are described in detail below.

In an embodiment, the groove is prepared using a computer numerical control (CNC) machine and polished using a high-precision float grinding and polishing actuator. After the groove is processed by the CNC machine, high-precision float grinding and polishing actuators are used to polish a circular arc surface, ensuring a smooth transition of a groove arc. Processing plus grinding and polishing may ensure the accuracy of groove preparation and meet the requirements of precise laser cladding.

After the groove preparation is completed, and laser cladding is performed using specific laser cladding parameters. By reasonably matching the groove form, size, and laser cladding parameters, the cladding quality of the laser cladding repaired layer is improved, and the cast steel axle box body is repaired in both high precision and high quality.

Below are detailed explanations of laser cladding methods based on groove preparation for different types of defects.

In the embodiments of the present application, if the defect type is determined to be a point defect, the corresponding groove form is a point cladding groove.

The processing parameters for point cladding groove are: a processing diameter of groove is d, and d≤15 millimeters; a processing depth of groove is h, and h=0.2+0.02d; a size of a rounded-corner at a bottom edge of formed notch is R3; and a roughness of a groove processing surface is Ra12.5.

Point defects include local rust corrosion and/or wear, with a processing depth generally ranging from 0.2-0.5 millimeters. In an embodiment, the processing diameter of groove d should not exceed 15 millimeters and should not be less than the diameter of the point defect, to comprehensively treat the defect. The processing depth of the groove is h=0.2+0.02d. An edge of the point notch forms a smooth transition surface R3 with a roughness of Ra12.5.

The preparation method of point cladding groove is: aligning the workpiece and adjusting its position, and the defect position is roughly relative to a Y-axis of the CNC machine; clamping a PML-2BL-R10.0 ball cutter on a CNC milling machine using a side milling head, programing and trial cutting, and observing whether the defect processing position is fully processed in place. Once there are no errors, processing may begin. Ball cutter processing parameter: speed of 2000 revolutions per minute; feeding rate of 2000 millimeters per minute, and cutting depth of 0.3 millimeters.

The point cladding groove transitions smoothly and regularly. Experiment shows that under the cladding parameters of laser power of 1500-2000 watts, the diameter of the laser spot of 4-5 millimeters, distance between a nozzle and the surface of the groove of 10-12 millimeters, scanning speed of 6-8 millimeters/second, powder feeding rate of 5-8 grams/minute, powder feeding gas flow rate of 6-8 liters/minute, and protective gas flow rate of 30-40 liters/minute, the laser cladding quality at the edge of the groove is good, and no porosity or cladding defects occur.

In the embodiments of the present application, if the defect type is determined to be a scratch defect, the corresponding groove form is a line cladding groove.

The processing parameters for line cladding groove: the groove processing width is m, and m≤5 millimeters; the processing depth of the groove is h, h=0.2+0.1m; the size of a rounded-corner at a bottom edge of formed notch is R=m; the roughness of the groove processing surface is Ra12.5.

Scratch defects are divided into two types: penetrative and closed, and the processing depth of scratch is generally 0.5-0.8 millimeters. The workpiece is processed or polished to form a smooth groove with a processing width of m, m≤5 millimeters. In an embodiment, m is not less than the scratch width to completely remove defect. The processing depth of the groove is h=0.2+0.1m, and the roughness is Ra12.5. To ensure the laser cladding effect, rounded corner transition treatment is adopted, with rounded corner R=m, to remove the defect.

The preparation method of line cladding groove is: aligning the workpiece and inspecting the approximate defect location on the machine, using RPMT1003 (R5) T8080 round blade T-shaped cutter on the CNC milling machine, programing and trial cutting based on the defect, adjusting the program and processing position until all defects may be removed, and proceeding with processing. Processing parameters of T-shaped cutter: rotation speed of 1000 revolutions per minute, feeding rate of 500 millimeters per minute, and cutting depth of 2 millimeters.

The line cladding groove is straight and smooth. Test shows that under the cladding parameters of laser power of 1500-2000 watts, the diameter of the laser spot of 3-5 millimeters, distance between a nozzle and the surface of the groove of 10-12 millimeters, scanning speed of 6-7 millimeters/second, powder feeding rate of 5-8 grams/minute, powder feeding gas flow rate of 6-7 liters/minute, and protective gas flow rate of 30-40 liters/minute, the laser cladding quality at the edge of the line cladding groove is good, and no porosity or cladding defect occur.

In the embodiments of the present application, if it is determined that the defect type is a curved surface defect, the corresponding groove form is a curved surface cladding groove.

The processing parameters for the curved surface cladding groove are: the processing depth of the groove is h, and the value of h ranges 0.2-0.5 millimeters; the rounded corner size of the bottom edge of the formed notch is R=10h; and the roughness of the groove processing surface is Ra12.5.

Surface defects include rust corrosion and/or wear on the surface, with a processing depth of 0.2-0.5 millimeters. Smooth transition surface is formed by processing the edge of the surface notch, with rounded corner R=10 h and roughness Ra12.5, to remove the defect.

The preparation method of curved surface cladding groove is as follows: aligning the workpiece and adjusting its position, and the defect position is roughly relative to the Y-axis of the machine; lamping a PML-2BL-R10.0 ball cutter on a CNC milling machine using a side milling head, programing and trial cutting, and observing whether the defect processing position is fully processed. The program processing position is adjusted to ensure that the defect position is fully processed before proceeding with the processing. Ball cutter processing parameters: speed of 2000 revolutions per minute, feeding rate of 2000 millimeters per minute, and cutting depth of 0.3 millimeters.

The curved surface cladding groove transitions smoothly with the curved surface, and a single-layer cladding may meet the processing volume of subtractive processing. Under the cladding parameters of laser power of 1500-2900 watts, the diameter of the laser spot of 4-5 millimeters, distance between a nozzle and the surface of the groove of 10-12 millimeters, scanning speed of 6-8 millimeters/second, powder feeding rate of 5-8 grams/minute, powder feeding gas flow rate of 6-8 liters/minute, and protective gas flow rate of 30-40 liters/minute, the laser cladding quality at the edge of the groove is good, and no porosity or cladding defect occurs.

In the embodiments of the present application, if the defect type is determined to be a surface defect, the corresponding groove form is a plane cladding groove.

The processing parameters for plane cladding groove are: the processing depth of the groove is h, and the value of h ranges 1.5-2 millimeters; the rounded corner size of the bottom edge of the formed notch is R=10h; and the roughness of the groove processing surface is Ra12.5.

Flat surface defects include rust corrosion and/or wear at a flat surface, with a regular processing depth of 1.5-2 millimeters. The edges of the pits are machined to form smooth transition surfaces, with rounded corners R=10 h and roughness of Ra12.5, to remove the defect.

The preparation method of plane cladding groove is as follows: aligning the workpiece and inspecting the approximate defect location on the machine, using RPMT1003 (R5) T8080 round blade T-shaped cutter on the CNC milling machine, programming and trial cutting based on the defect, adjusting the programmed processing position until all defects may be removed, and proceeding with processing. Processing parameters of T-shaped cutter: speed of 1000 revolutions per minute, feeding rate of 500 millimeters per minute, cutting depth of 2 millimeters in lateral direction and 1 millimeter in Z direction.

The plane groove has a smooth transition and a large groove depth, and 2 layers of cladding is required to ensure the subtractive processing volume after adding materials. Under the cladding parameters of laser power of 1800-2300 watts, the diameter of the laser spot of 4-5 millimeters, distance between a nozzle and the surface of the groove of 10-12 millimeters, scanning speed of 6-8 millimeters/second, powder feeding rate of 10-15 grams/minute, powder feeding gas flow rate of 6-8 liters/minute, and protective gas flow rate of 30-40 liters/minute, the laser cladding quality at the edge of the groove is good, and no porosity or cladding defect occurs between layers.

In the embodiments of the present application, if the defect type is determined to be a part edge defect, the corresponding groove form is a part edge groove.

The processing parameters for the part edge groove are: the processing depth of the groove is h, h≤2 millimeters; the rounded corner size of the bottom deviating from the part edge is R=10h; the groove processing width is m, m=m1+2, where m1 is the width of the rounded corner and 2 is the width of the flat part; the roughness of the groove processing surface is Ra12.5.

Edge defects of the part include rust corrosion and wear on the edges, with a processing depth of h, h≤2 millimeters. The processing width of the groove is m, and it is processed to form a combination of flat and smooth transition surfaces, m=m1+2. m1 is the width of the rounded corner, 2 is the width of the flat part (in millimeters), rounded corner R=10h, and roughness is Ra12.5.

The preparation method for the part edge groove is: aligning the workpiece and inspecting the approximate defect location on the machine, using GM-4R-D10.0R1.0 round nose milling cutter on the CNC milling machine, programming and trial cutting based on the defect, adjusting the programmed processing position until all defects may be removed, and proceeding with processing. Round-nose milling cutter machining parameters: speed of 3000 revolutions per minute, feeding rate of 2000 millimeters per minute, cutting depth of 0.3 millimeters.

The part edge groove has a smooth transition and a large groove depth, and two layers of cladding is required to ensure the subtractive processing volume after adding materials. Under the cladding parameters of laser power of 1800-2300 watts, the diameter of the laser spot of 4-5 millimeters, distance between a nozzle and the surface of the groove of 10-12 millimeters, scanning speed of 6-8 millimeters/second, powder feeding rate of 10-15 grams/minute, powder feeding gas flow rate of 6-8 liters/minute, and protective gas flow rate of 30-40 liters/minute, the laser cladding quality at the edge of the groove is good, and no porosity or cladding defect occurs between layers.

In the embodiments of the present application, the step S2 of performing procedure optimization and procedure qualification further includes:
S21: building, based on the defect characteristic and performance of the cladding material, a repair procedure parameter model to perform the procedure optimization and sample preparation;
S22: performing corresponding qualification tests on various types of cladding samples obtained from the sample preparation to obtain a result of the procedure qualification; and
S23: providing feedback and modifying the procedure optimization based on the result of the procedure qualification.

By the step of performing procedure optimization and procedure qualification, as well as the step of performing quality evaluation on the cladding layer described in this repair method, the performance indicators of the cladding layer may be evaluated at the lowest cost during the preparation stage of the process sample, to provide feedback and correct the procedure optimization, achieve strong support and benign closed-loop control for the development of laser cladding process, and effectively solve the problem of scrapped train parts due to corrosion and wear that cannot be repaired, reduce the repair cost of carbon steel parts, and prolong the service life of parts.

In the embodiments of the present application, a to-be-repaired product is classified based on defect types. In the subsequent procedure optimization and sample preparation, corresponding samples may be finely prepared based on defect types to improve the accuracy and reliability of qualification tests on cladding samples.

In the embodiments of the present application, the procedure optimization includes determining an optimal procedure parameter based on main factors of the repair procedure parameter model during laser cladding repair, through an orthogonal coupling experiment in combination with a range analysis.

Preferably, the main factors of the repair procedure parameter model include a laser power, a scanning speed, and a powder feeding rate. The most preferred repair procedure parameter model is: selecting a suitable laser based on the structural characteristics, defect types, usage requirements, and performance of the cladding material of the cast steel axle box, to determine five main parameter combinations of the diameter of the laser spot, the laser power, the scanning speed, the powder feeding rate, and a distance between a nozzle and the surface of the groove as the main factors of the repair procedure parameter model. Orthogonal coupling laser cladding process experiments are performed to select the optimal laser cladding procedure parameter.

In some embodiments, the determined procedure optimization conditions are laser power: 1500-2500 W; scanning speed: 250-400 mm/min; powder feeding rate: 1-2 r/min.

In the embodiments of the present application, the powder feeding rate is 1 r/min≈6.4 g/min.

In the embodiments of the present application, the step S21 of building, based on the defect characteristic and performance of the cladding material, a repair procedure parameter model further includes:
S211: determining to-be-repaired morphology parameter of the to-be-repaired part based on the defect characteristic, and building the repair procedure parameter model, where the to-be-repaired morphology parameters include a cladding width, a cladding height, and a dilution rate; and
S212: setting the procedure parameter for the laser cladding repair procedure based on the repair procedure parameter model and the to-be-repaired morphology parameter.

In an embodiment, the step S211 of determining the to-be-repaired morphology parameter of the to-be-repaired part based on the defect characteristic, and building the repair procedure parameter model further includes:
step 211-1: selecting, in sequence, one of the procedure parameters of the laser cladding repair procedure as an only test variable parameter, and performing a single-pass cladding layer single-factor test, where
the procedure parameters of the laser cladding repair procedure include at least the laser power, the scanning speed, the powder feeding rate, and the diameter of the laser spot;
step 211-2: obtaining a set of cladding quality parameters for a single-pass cladding layer, where the cladding quality parameters include the cladding width, the cladding height, and the dilution rate; and
step 211-3: building the repair procedure parameter model based on the set of cladding quality parameters.

In step 211-1, laser power refers to the energy output of the laser per unit time. Laser cladding is generally achieved by emitting a laser beam from a semiconductor or fiber laser. The scanning speed is the length of the cladding per unit time. The powder feeding rate refers to the amount of powder fed per unit time, which directly affects the cladding efficiency and quality. The diameter of the laser spot refers to the size of the laser spot. The diameter of the laser spot does not have a significant impact on the depth and height of the cladding, but has a significant impact on the width of the cladding.

When the effect of laser power on the cladding quality of a single-pass cladding layer is tested, the scanning speed, the powder feeding rate, and the diameter of the laser spot are pre-determined, and laser power is used as an only experimental variable to test the effects of different laser powers on the cladding width, height, and dilution rate of the single-pass cladding layer; when the effect of scanning speed on the quality of single-pass cladding is tested, the laser power, powder feeding rate, and diameter of the laser spot are pre-determined, and scanning speed is used as an only experimental variable to test the effects of different scanning speeds on the width, height, and dilution rate of single-pass cladding; when the effect of powder feeding rate on the cladding quality of a single-pass cladding layer is tested, the laser power, scanning speed, and diameter of the laser spot are pre-determined, and the powder feeding rate is used as an only experimental variable to test the effects of different powder feeding rates on the cladding width, cladding height, and dilution rate of the single-pass cladding layer; when the effect of diameter of the laser spot on the cladding quality of a single-pass cladding layer is tested, the laser power, scanning speed, and powder feeding rate are pre-determined, and the diameter of the laser spot is used as an only experimental variable to test the effects of different diameter of the laser spots on the cladding width, cladding height, and dilution rate of the single-pass cladding layer.

In step 211-2, the cladding quality of a single-pass cladding layer is evaluated based on the cladding width, the cladding height, and the dilution rate. The cladding width refers to the width produced on the surface of the workpiece after the metal powder cladding during the cladding process, cladding height refers to the maximum height of the cladding layer exceeding the cladding surface of the workpiece, and the dilution rate refers to the degree of change in the alloy composition of the cladding layer caused by the mixing of the cladding workpiece substrate in laser cladding, expressed as the percentage of the workpiece substrate alloy in the total cladding layer.

In step 211-3, a nonlinear data fitting method is used to built the laser cladding procedure parameter model.

In the embodiments of the present application, the laser cladding procedure parameter model is:

$$D = 0.8 \times {X}^{- 2} \times {K}^{1.8} + 0.9 \times ( 3.5 - R ) ,$$

$$H = 0.4 \times ( {X}^{- 0.9} ) \times {K}^{0.4} + 0.2 \times ( 3.5 - R ) , and$$

$$W = 2.2 \times ( {X}^{- 0.5} ) \times {K}^{0.4} - 0.4 \times ( 3.5 - R ) ,$$

where

D is the dilution rate; H is the cladding height, by a unit of millimeters; W is the cladding width, by a unit of millimeters; X is the powder feeding rate, by a unit of revolutions per minute; K is the laser energy density, K=P/V, P is the laser power measured in watts, V is the scanning speed by a unit of millimeters per minute, or millimeters per second; and R is the diameter of the laser spot by a unit of millimeters.

In the embodiments of the present application, selecting, in sequence, one of the procedure parameters of the laser cladding repair procedure as an only test variable parameter, and performing a single-pass cladding layer single-factor test includes:
establishing test value pools for the laser power, the scanning speed, the powder feeding rate, and the diameter of the laser spot respectively, where
a numerical range of the test value pool for the laser power is 1700 W˜2600 W;
a numerical range of the test value pool for the scanning speed is between 350 mm/min and 600 mm/min;
a numerical range of the test value pool for the powder feeding rate is 6.36 grams/minute to 13.99 grams/minute; and
a range of the test value pool for the diameter of the laser spot is 3.0 millimeters to 6.0 millimeters.

Since the effect of each laser cladding procedure parameter on the quality of a single-pass cladding layer need to be tested and the set of cladding quality parameters is summarized, it is necessary to set a threshold for each procedure parameter. During each experiment, a determined value should be selected as the experimental parameter within the threshold. A plurality of values may be selected within the threshold to perform a plurality of experiments, thereby obtaining more experimental data, improving the accuracy of experimental data, and reducing accidental errors.

In the embodiments of the present application, selecting, in sequence, one of the procedure parameters of the laser cladding repair procedure as an only test variable parameter, and performing a single-pass cladding layer single-factor test includes:
setting the scanning speed to 350 millimeters per minute, the powder feeding rate to 11.45 grams per minute, and the diameter of the laser spot to 4.0 millimeters; and
setting the laser power to 1700 W, 2000 W, 2300 W, and 2600 W in sequence, and performing single-pass cladding layer single-factor test respectively.

Under the parameter settings of scanning speed of 350 mm/min, the powder feeding rate of 11.45 g/min, and the diameter of the laser spot of 4.0 mm, the laser power is adjusted to 1700 W to perform the single-pass cladding layer single-factor test; then the scanning speed of 350 millimeters per minute, the powder feeding rate of 11.45 grams per minute, and the diameter of the laser spot of 4.0 millimeters are maintained, and the laser power is adjusted to 2000 W to perform the single-pass cladding layer single-factor test. Similarly, the scanning speed of 350 millimeters per minute, the powder feeding rate of 11.45 grams per minute, and the diameter of the laser spot of 4.0 millimeters are maintained, the laser power is adjusted to 2300 W to perform the single-pass cladding layer single-factor test. The scanning speed of 350 millimeters per minute, the powder feeding rate of 11.45 grams per minute, and the diameter of the laser spot of 4.0 millimeters are maintained, the laser power is adjusted to 2600 watts to perform the single-pass cladding layer single-factor test. Furthermore, a plurality of sets of experiments may be performed under the same laser power parameter to obtain more experimental data. By using the above steps, the numerical sets of the cladding width, cladding height, and dilution rate of the single-pass cladding layer may be obtained for laser powers of 1700 W, 2000 W, 2300 W, and 2600 W, respectively. In the embodiments of the present application, through data analysis, it may be concluded that the cladding width and dilution rate of a single-pass cladding layer increase with the increase of laser power, and the variation pattern of cladding height is not obvious.

When the effect of laser power on the cladding quality of a single layer is tested, the scanning speed, powder feeding rate, and diameter of the laser spot may also be set to other values. For example, the scanning speed may be set to 400 mm/min, the powder feeding rate may be set to 13.99 g/min, the diameter of the laser spot may be set to 5.5 mm, and then the laser power may be set to 1700 W, 2000 W, 2300 W, and 2600 W for single-pass cladding layer single-factor test.

In the embodiments of the present application, selecting, in sequence, one of the procedure parameters of the laser cladding repair procedure as an only test variable parameter, and performing a single-pass cladding layer single-factor test includes:
setting the laser power to 2000 W, the powder feeding rate to 11.45 g/min, and the diameter of the laser spot to 4.0 mm; and
setting the scanning speed to 350 mm/min, 400 mm/min, 450 mm/min, 500 mm/min, 550 mm/min, and 600 mm/min in sequence, and performing single-pass cladding layer single-factor tests respectively.

Under the parameter settings of a laser power of 2000 W, a powder feeding rate of 11.45 g/min, and a diameter of the laser spot of 4.0 mm, the scanning speed is adjusted to 350 mm/min to perform the single-pass cladding layer single-factor test; then the laser power of 2000 W, the powder feeding rate of 11.45 g/min, the diameter of the laser spot of 4.0 mm are maintained, and the scanning speed is adjusted to 400 mm/min to perform a single-pass cladding layer single-factor test. Similarly, the laser power of 2000 W, the powder feeding rate of 11.45 g/min, and the diameter of the laser spot of 4.0 mm are maintained, the scanning speed is adjusted to 450 mm/min to perform a single-pass cladding layer single-factor test. The laser power of 2000 W, the powder feeding rate of 11.45 g/min, and the diameter of the laser spot of 4.0 mm are maintained, and the scanning speed is adjusted to 500 mm/min to perform a single-pass cladding layer single-factor test. The laser power of 2000 W, the powder feeding rate of 11.45 g/min, the diameter of the laser spot of 4.0 mm are maintained, and the scanning speed is adjusted to 550 mm/min to perform a single-pass cladding layer single-factor test. The laser power of 2000 W, the powder feeding rate of 11.45 g/min, and the diameter of the laser spot of 4.0 mm are maintained, the scanning speed is adjusted to 600 mm/min to perform a single-pass cladding layer single-factor test. Furthermore, a plurality of sets of tests may be performed under the same scanning speed parameter to obtain more experimental data. By using the above steps, a set of numerical values for the cladding width, cladding height, and dilution rate of a single-pass cladding layer may be obtained at scanning speeds of 350 mm/min, 400 mm/min, 450 mm/min, 500 mm/min, 550 mm/min, and 600 mm/min. In the embodiments of the present application, through data analysis, it may be concluded that the cladding height and dilution rate of a single-pass cladding layer decrease with the increase in the scanning speed. There is no obvious consistent trend of the cladding width increasing with scanning speed when the laser power remains constant.

When the effect of scanning speed on the quality of single-pass cladding is tested, the laser power, powder feeding rate, and diameter of the laser spot may also be set to other values. For example, the laser power is set to 2300 W, powder feeding rate is set to 13.99 g/min, diameter of the laser spot is set to 5.5 mm, and then the scanning speed is set to 350 mm/min, 400 mm/min, 450 mm/min, 500 mm/min, 550 mm/min, 600 mm/min, and single factor tests are performed on single-pass cladding.

In the embodiments of the present application, selecting, in sequence, one of the procedure parameters of the laser cladding repair procedure as an only test variable parameter, and performing a single-pass cladding layer single-factor test includes:
setting the laser power to 2000 W, the scanning speed to 350 mm/min, and the diameter of the laser spot to 4.0 mm; and
setting the powder feeding rates to 6.36 g/min, 8.90 g/min, 11.45 g/min, and 13.99 g/min in sequence, and performing single-pass cladding layer single-factor tests respectively.

Under the parameter settings of laser power of 2000 W, scanning speed of 350 mm/min, and diameter of the laser spot of 4.0 mm, the powder feeding rate is adjusted to 6.36 g/min to perform a single-pass cladding layer single-factor test; then the laser power of 2000 W, the scanning speed of 350 mm/min, and the diameter of the laser spot at 4.0 mm are maintained, and the powder feeding rate is adjusted to 8.90 g/min to perform a single-pass cladding layer single-factor test. Similarly, the laser power of 2000 W, the scanning speed of 350 mm/min, and the diameter of the laser spot of 4.0 mm are maintained, and the powder feeding rate is adjusted to 11.45 g/min to perform a single-pass cladding layer single-factor test. The laser power of 2000 W, the scanning speed of 350 mm/min, and the diameter of the laser spot of 4.0 mm are maintained, and the powder feeding rate is adjusted to 13.99 g/min to perform a single-pass cladding layer single-factor test. Furthermore, under the same powder feeding rate parameter, a plurality of sets of tests may be performed to obtain multiple test data. By using the above steps, the numerical sets of the cladding width, cladding height, and dilution rate of the single-pass cladding layer may be obtained for powder feeding rates of 6.36 g/min, 8.90 g/min, 11.45 g/min, and 13.99 g/min. In the embodiments of the present application, through data analysis, it may be concluded that the cladding height of a single-pass cladding layer increases with the increase in powder feeding rate, but there is no obvious change in cladding width, and the dilution rate shows a decreasing trend with the increase of powder feeding rate.

When the effect of powder feeding rate on the cladding quality of a single layer is tested, the laser power, scanning speed, and diameter of the laser spot may also be set to other values. For example, the laser power is set to 2300 W, the scanning speed is set to 400 mm/min, and the diameter of the laser spot is set to 5.5 mm, then the powder feeding rate is set to 6.36 g/min, 8.90 g/min, 11.45 g/min, and 13.99 g/min, respectively to perform a single-pass cladding layer single-factor test.

In the embodiments of the present application, selecting, in sequence, one of the procedure parameters of the laser cladding repair procedure as an only test variable parameter, and performing a single-pass cladding layer single-factor test includes:
setting the laser power to 2000 W, the scanning speed to 350 mm/min, and powder feeding rate to 6.36 g/min; and
setting the diameter of the laser spot to 3.0 millimeters, 3.5 millimeters, 4.0 millimeters, 4.5 millimeters, 5.0 millimeters, 5.5 millimeters, and 6.0 millimeters in sequence, and performing single-pass cladding layer single-factor tests respectively.

Under the parameter settings of laser power of 2000 W, the scanning speed of 350 mm/min, and the powder feeding rate of 6.36 g/min, the diameter of the laser spot is adjusted to 3.0 mm to perform a single-pass cladding layer single-factor test; then the laser power of 2000 W, the scanning speed of 350 mm/min and the powder feeding rate at 6.36 g/min are maintained, and the diameter of the laser spot is adjusted to 3.5 mm to perform a single-pass cladding layer single-factor test; similarly, a laser power of 2000 W, a scanning speed of 350 mm/min, a powder feeding rate of 6.36 g/min are maintained, and the diameter of the laser spot is adjusted to 4.0 mm to perform a single-pass cladding layer single-factor test. The laser power of 2000 W, the scanning speed of 350 mm/min and the powder feeding rate of 6.36 g/min are maintained, and the diameter of the laser spot is adjusted to 4.5 mm to perform a single-pass cladding layer single-factor test. The laser power of 2000 W, the scanning speed of 350 mm/min and the powder feeding rate of 6.36 g/min are maintained, and the diameter of the laser spot is adjusted to 5.0 mm to perform a single-pass cladding layer single-factor test; a laser power of 2000 W, a scanning speed of 350 mm/min, a powder feeding rate of 6.36 g/min are maintained, and the diameter of the laser spot is adjusted to 5.5 mm to perform a single-pass cladding layer single-factor test. The a laser power of 2000 W, the scanning speed of 350 mm/min and the powder feeding rate of 6.36 g/min are maintained, and the diameter of the laser spot is adjusted to 6.0 mm to perform a single-pass cladding layer single-factor test. Furthermore, a plurality of sets of experiments may be performed under the same laser power parameter to obtain more experimental data. By using the above steps, the numerical sets of the cladding width, cladding height, and dilution rate of the single-pass cladding layer may be obtained for diameter of the laser spots of 3.0 millimeters, 3.5 millimeters, 4.0 millimeters, 4.5 millimeters, 5.0 millimeters, 5.5 millimeters, and 6.0 millimeters, respectively. In the embodiments of the present application, through data analysis, it may be concluded that the cladding width of a single-pass cladding layer increases with the increase in the diameter of the laser spot. The effect of the diameter of the laser spot on the cladding depth and height is not significant. When the diameter of the laser spot increases, the dilution rate may be reduced and the cladding layer pass may be reduced.

When the effect of diameter of the laser spot on the quality of single-pass cladding is tested, the laser power, scanning speed, and powder feeding rate may also be set to other values. For example, the laser power is set to 2300 W, scanning speed is set to 400 mm/min, and powder feeding rate is set to 8.90 g/min, and then the diameter of the laser spot is set to 3.0 mm, 3.5 mm, 4.0 mm, 4.5 mm, 5.0 mm, 5.5 mm, and 6.0 mm, respectively to perform single-pass cladding layer single-factor tests.

According to the method for building a laser cladding procedure parameter model provided in the embodiments of the present application, the effects of laser power, scanning speed, powder feeding rate, and diameter of the laser spot on cladding width, cladding height, and dilution rate are tested respectively. The experimental results are non-linearly fitted to obtain a laser cladding procedure parameter model. In an embodiment, the laser cladding procedure parameters associated with the experiment, including laser power, scanning speed, powder feeding rate, and diameter of the laser spot, are first determined. Then, each of the above parameters is used as an only variable for single-pass cladding layer single-factor test. The quality parameters of the single-pass cladding layer, such as cladding width, cladding height, and dilution rate, are used as evaluation indicators to study the effect of a single parameter on the forming quality of the single-pass cladding layer. For example, to test the effect of laser power on the cladding width, cladding height, and dilution rate of a single-pass cladding layer, under the premise of pre-determined scanning speed, powder feeding rate, and diameter of the laser spot, laser power is used as the only experimental variable to test the effect of different laser powers on the cladding width, cladding height, and dilution rate of a single-pass cladding layer. Using cladding width, cladding height, and dilution rate as evaluation indicators, the effect of laser power on the cladding quality of a single-pass cladding layer is analyzed. After the set of cladding quality parameters for each parameter of a single-pass cladding layer is obtained, the data is fitted non-linearly to obtain a laser cladding procedure parameter model:

$$D = 0.8 \times {X}^{- 2} \times {K}^{1.8} + 0.9 \times ( 3.5 - R ) ,$$

$$H = 0.4 \times ( {X}^{- 0.9} ) \times {K}^{0.4} + 0.2 \times ( 3.5 - R ) , and$$

$$W = 2.2 \times ( {X}^{- 0.5} ) \times {K}^{0.4} - 0.4 \times ( 3.5 - R ) ,$$

where

D is the dilution rate; H is the cladding height; W is the cladding width; X is a powder feeding rate; K is the laser energy density, K=P/V, P is the laser power, and V is the scanning speed; and R is the diameter of the laser spot. The above model directly reflects the numerical correspondence between the dilution rate, the cladding height, the cladding width, the powder feeding rate, the laser energy density, and the diameter of the laser spot. That is to say, when the laser cladding procedure parameters are set, the values of the powder feeding rate, the laser energy density, and the diameter of the laser spot may be directly determined by directly substituting the dilution rate, the cladding height, and the cladding width are directly substituted into the above calculation model. Furthermore, the relationship between laser power and scanning speed may be determined by the laser energy density, the laser cladding apparatus may be controlled to perform laser cladding operations with the set parameters, improving the efficiency of laser cladding operations and ensuring cladding quality. In summary, a laser cladding procedure parameter calculation model is built using the method for building a laser cladding procedure parameter model provided by the embodiments of the present application. This enables low-cost and rapid setting of laser cladding procedure parameter, improves parameter accuracy, ensures laser cladding quality, and enhances laser cladding efficiency.

In the embodiments of the present application, in step 211 mentioned above, the to-be-repaired morphology parameters required for laser cladding repair may be determined based on the defect types on the workpiece surface. The to-be-repaired morphology parameters include the required cladding width, cladding height, and dilution rate. Defect types may be classified into different corrosion conditions such as scratches, rust corrosion, and pits.

In the embodiments of the present application, in step 212, after the cladding width, cladding height, and dilution rate are determined, the above parameter values may be directly substituted into the laser cladding procedure parameter model:

$$D = 0.8 \times {X}^{- 2} \times {K}^{1.8} + 0.9 \times ( 3.5 - R ) ,$$

$$H = 0.4 \times ( {X}^{- 0.9} ) \times {K}^{0.4} + 0.2 \times ( 3.5 - R ) , and$$

$$W = 2.2 \times ( {X}^{- 0.5} ) \times {K}^{0.4} - 0.4 \times ( 3.5 - R ) ,$$

to calculate the laser energy density K, the powder feeding rate X, and the diameter of the laser spot R, where K=P/V, and then both the laser power P and scanning speed V are adjusted based on the defect type. For example, when the repair area is large, a larger scanning speed may be chosen in case that the laser energy density K remains unchanged to save laser cladding repair time and ensure a smaller amount of deformation and a smaller laser power may be chosen when thinner surfaces is repaired.

In the embodiments of the present application, a set of optimal laser cladding procedure parameter setting range values are provided, namely, the laser power setting ranges 1700-2600 W, the scanning speed setting ranges 360-600 mm/min, the powder feeding rate setting ranges 6.36-13.99 g/min, and the diameter of the laser spot setting ranges 3.0-6.0 mm. Furthermore, the distance between the laser cladding nozzle and the to-be-repaired surface of the workpiece is set within a range of 8-12 millimeters, the powder feeding gas flow rate is set within a range of 6-8 liters/minute, and the protective gas flow rate is set within a range of 30-40 liters/minute. An extremely low dilution rate may be obtained based on the above parameter settings, while the cladding layer is well cladded and the performance meets the requirements.

According to the laser cladding procedure parameter setting method provided in the embodiments of the present application, the laser cladding procedure parameter model is applied to calculate the laser cladding procedure parameter, where the laser cladding procedure parameter model is:

$$D = 0.8 \times {X}^{- 2} \times {K}^{1.8} + 0.9 \times ( 3.5 - R ) ,$$

$$H = 0.4 \times ( {X}^{- 0.9} ) \times {K}^{0.4} + 0.2 \times ( 3.5 - R ) , and$$

$$W = 2.2 \times ( {X}^{- 0.5} ) \times {K}^{0.4} - 0.4 \times ( 3.5 - R ) .$$

When the parameters of laser cladding process are set, the parameter values of the powder feeding rate, the laser energy density, and the diameter of the laser spot may be directly determined by directly substituting the dilution rate, the cladding height, and the cladding width into the above calculation model. Furthermore, the relationship between laser power and scanning speed may be determined by the laser energy density, and the laser cladding apparatus may be controlled to perform laser cladding operations with the set parameters, improving the efficiency of laser cladding operation and ensuring the quality of cladding. In summary, the method for setting laser cladding procedure parameter provided in the embodiments of the present application may be used to set laser cladding procedure parameter at low cost and quickly, improve parameter accuracy, ensure laser cladding quality, and enhance laser cladding efficiency.

Based on the above content, in the step of making the cladding process described in the embodiments of the present application, an expert database of cladding procedure parameter for different corrosion conditions such as scratches, rust, and pits is established based on the qualification test verification data of laser cladding. Appropriate cladding repair procedure parameters corresponding to different defect types are selected and the specific application of these parameters, such as laser power, the diameter of the laser spot, powder feeding rate, scanning speed, and cladding amount, to the working conditions of cast steel axle box bodies is identified and fed back by the laser cladding system detector.

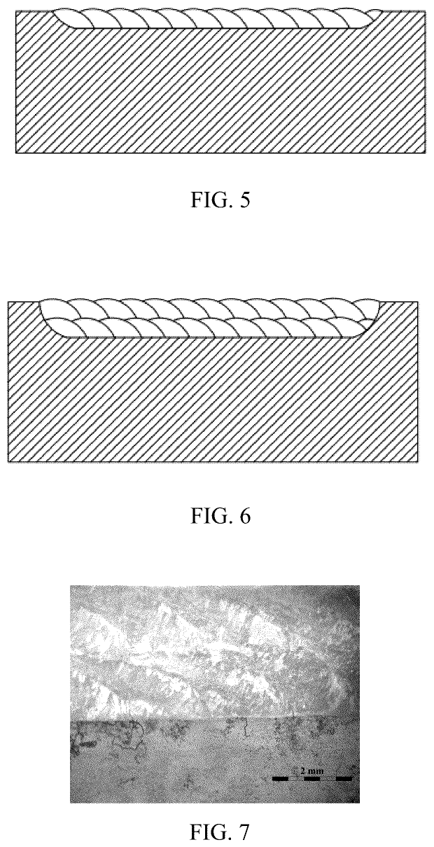

In the repair method of the embodiments of the present application, after the above procedure optimization, it is preferred to use a large spot of 3 mm-6 mm as the laser thermal source. Experiment shows that by using a large light spot as a laser thermal source, the repaired cladding layer is low in the dilution rate during laser cladding repair, which reduces the number of passes of cladding layers. Furthermore, the optimal procedure parameter for laser cladding process are set as follows: laser power of 2000-3000 W, the diameter of the laser spot of 4-6 mm, a distance between a nozzle and the surface of the groove of 8-12 mm, the scanning speed of 6-10 mm/s, the powder feeding rate of 5-12 g/min, the powder feeding gas flow rate of 6-8 L/min and the protective gas flow rate of 30-40 L/min. The optimal procedure parameter of this laser cladding process may obtain extremely low dilution rates, as well as goof cladding of the cladding layer and the performance meeting the requirements. The macroscopic photo of the cladding layer is shown in FIG. 6.

In the embodiments of the present application, based on the above-mentioned defect characteristics, the repaired cladding layer includes single-layer cladding, double-layer cladding, or multi-layer cladding. The preferred single-layer thickness for the cladding layer is about 1 mm, with an overlap rate of about 40% and a defect depth of less than 1 mm. One layer of cladding is preferable. If the defect depth exceeds 1 mm, two layers of cladding is preferable. In the repair method described in the embodiments of the present application, an interlayer temperature is controlled between 130° C. and 160° C. during the process of cladding a plurality of layers, and interlayer cleaning is performed to remove the oxide scale. In an embodiment, the preferred cladding path for multi-layer cladding is a straight or curved line.

In the embodiments of the present application, the preparation of the sample described in step S21 refers to preparing a cladding layer from the to-be-selected powder on a substrate pf the axle box body using the laser cladding repair method. In some embodiments, laser cladding is performed on the surface of the substrate to prepare a single-pass cladding sample.

In an embodiment, the sample is prepared from each to-be-selected powder using the same process.

The content of sample preparation is described in detail below combined with the qualification test.

In the embodiments of the present application, before step S22, there is also an apparatus self-check step. The apparatus self-check steps include apparatus self-check, power detection, and cladding material preparation. Apparatus self-check refers to a process of a self-check after the repair apparatus is turned on, checking whether the key functional indicators of apparatus such as laser, a laser cladding head, a powder feeder, a chiller, and a control cabinet are normal. Power detection refers to the process of performing power detection once a month after the repair apparatus is turned on normally. A power meter is used to inspect whether the laser power of the repair apparatus is consistent with the set power, ensuring that the deviation of the laser power from the set theoretical value is not more than 2%. Cladding material preparation refers to a process of drying the powder of the cladding material to be used in a dryer before adding it to ensure smooth powder feeding of the repair apparatus, and then adding the powder to the powder feeder.

In the embodiments of the present application, the qualification test described in step S22 includes macroscopic observation and microstructure observation, as well as fretting friction wear test, and investigating a dilution rate of the cladding layer of the cladding sample.

Through macroscopic observation and microstructure observation, laser cladding samples may be visually observed and subjected to microscopic penetrant testing. The dilution rate, the overlap rate, cracks, inclusions, and delamination of the cladding layer of the cladding sample may be determined through sample analysis. A lower dilution rate and reasonable overlap rate may obtain smaller deformation and residual stress of the sample, and reduce the effect on the substrate structure. This evaluation method may provide feedback and adjust the process model through qualification tests, thereby controlling the dilution rate of the cladding layer that meets the evaluation requirements at a lower level, and the overlap rate control level at a higher level, which well meets the requirements of part size repair. The preparation requirements, evaluation requirements, and experiments of the corresponding cladding samples for macroscopic observation and microstructure observation will be described in detail below, and will not be repeated here.

Fretting wear is a form of part failure occurring under the operating conditions of rail vehicles. In the evaluation method described in the present application, the fretting friction wear performance of the cladding layer is evaluated by performing impact-shear composite fretting friction wear test on the cladding layer of the cladding sample, and is compared the performance of the substrate to ensure that the repaired cladding layer has approximate performance to the substrate, making the cladding layer that meets the evaluation requirements well meet the requirements of part size repair. The preparation requirements, evaluation requirements, and experiments of the corresponding cladding samples for fretting friction wear test will be described in detail below, and will not be repeated here.

In an embodiment, single-pass cladding is performed on the substrate, and based on the defect types of the to-be-repaired product mentioned above, samples are taken from the area where the cladding layer is located on the substrate to prepare the cladding sample.

If the defect is a point defect, a single-pass cladding is performed at the corresponding point defect of the substrate to form a point cladding layer. The point cladding layer completely fills and covers the point defect, and the sampling area of the point defect covers at least the cladding layer at the point defect.

If the defect is a line defect, a single-pass cladding is performed at the corresponding line defect of the substrate to form a line cladding layer, which completely fills and covers the line defect. To consider factors such as stress distribution during the laser cladding process, two sets of line defect sampling areas are provided by sampling at both ends of the cladding layer at the line defect location.

Due to the small defect area and negligible lateral width of point and line defects, the qualification testing for point and line defect mainly focus on macroscopic observation and microstructure observation, and metallographic analysis. Macroscopic observation and microstructure observation are mainly based on visual inspection and penetrant inspection, and direct sampling and testing may be carried out in the cladding zone of point defect and line defect.

If the defect is a surface defect, a single-pass cladding with a certain area is performed at the corresponding surface defect of the substrate to form a plane cladding layer. Based on the qualification test described in the present application, samples are sequentially taken along the cladding direction on the cladding layer at the surface defect to prepare cladding samples corresponding to various qualification tests described in the embodiments of the present application. The sampling principles and sampling locations of the cladding samples corresponding to various qualification tests are described in detail in conjunction with the following qualification tests.

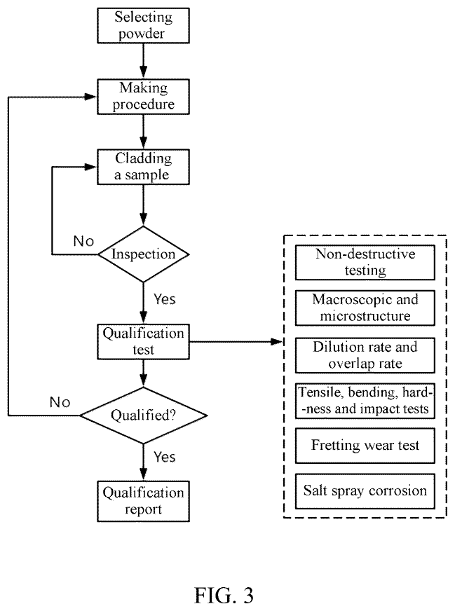

In an embodiment, as shown in FIG. 3, the qualification tests in step S22 of the embodiments of the present application further include the following testing:
macroscopic observation and microstructure observation;
hardness test, tensile test, and impact test;
fretting friction wear test
salt spray corrosion, and electrochemical corrosion;
micro shear test and bending performance test; and
fatigue test.

In an embodiment, the above testing should be selected based on the structural characteristics, defect types, usage requirements (working conditions), and performance of the cladding material of the substrate of the to-be-repaired part. As shown in FIG. 3, the qualification test included in the evaluation method described in the embodiments of the present application preferably includes at least macroscopic observation and microstructure observation, and fretting friction wear test. Further optimized qualification tests include at least macroscopic observation and microstructure observation, hardness test, tensile test, impact test, fretting friction wear test, and salt spray corrosion test.

Furthermore, before the aforementioned qualification test, the evaluation method described in the embodiments of the present application also includes non-destructive testing. Through non-destructive testing, metal powder with defects such as cracks and pores inside the cladding layer may be screened out, and the procedure of sample cladding may be further fed back and corrected to ensure the quality of the laser cladding process involved in the sample preparation in this evaluation method, and to ensure higher data reliability and accuracy in subsequent qualification tests.

In the embodiments of the present application, the step S22 of performing corresponding qualification tests on various types of cladding samples obtained from the sample preparation to obtain a result of the procedure qualification includes the following.

S220, non-destructive testing.

In an embodiment, the non-destructive testing described in this repair method is provided before the qualification test and/or after the subsequent laser cladding repair procedure is performed. Non-destructive testing includes: penetrant testing and X-ray testing.

In an embodiment, the non-destructive testing includes: penetrant testing and X-ray testing. In some embodiments, the inspection method refers to: TB/T 1558.5-2010 Non-destructive testing of Welds on Rolling Stock Part 5: penetrant testing, and the penetrant testing is performed on the surface cracks of the cladding layer; for the cladding layer of the axle box body, it is also necessary to follow TB/T 1558.3 Non-destructive testing of Welds on Rolling Stock Part 3: Radiographic testing.

In an embodiment, visual observation is performed on the overall cladding layer on the substrate, which shows no cracks, pores, or poor cladding defect. The thickness of the overall cladding layer meets the requirements for subtractive processing; after polishing the surface of the overall cladding layer on the substrate, a penetrant testing is carried out, and there are no defect on the surface; radiographic testing is performed on the overall cladding layer on the substrate, and there are no defect inside; the surface of the substrate is processed by mechanical processing to make it flat and smooth, and then subjected to penetrant testing again. After the surface is free of defect, samples are taken, and the corresponding roughness of the cladding sample is 6.3.

In an embodiment, non-destructive testing is performed before the qualification test. If the part is qualified, it will proceed to the next process; otherwise, it will return to the previous process for sample cladding again.

In an embodiment, non-destructive testing is performed after the subsequent laser cladding repair procedure, and if the part is qualified, it enters the next process; otherwise, it will return to the defect assessment and removal process and re-perform the groove preparation.

S221: daily qualification test, where the qualification test further includes the following.

S221-1: macroscopic observation and microstructure observation mentioned above.

In an embodiment, macroscopic observation refers to visual observation of the surface shape of the cladding layer of the cladding sample, i.e., observing whether the surface of the cladding layer is smooth and flat, whether the appearance is well formed, whether there are cracks, and whether the thickness of the cladding layer meets the allowance for subtractive processing. In an embodiment, if the surface of the cladding layer is smooth and flat, the appearance is well formed, there are no cracks, and the thickness of the cladding layer meets the requirements for subtractive processing, it indicates that the procedure parameter model developed in the evaluation method meets the evaluation requirements, and the repaired part meets the usage requirements; otherwise, it does not meet the evaluation and usage requirements, and feedback is required to readjust the procedure parameter model. In an embodiment, by visually observing the surface shape of the cladding layer and comparing the cracking phenomenon, it may be fed back to the preliminary powder selection step to screen out powder that are prone to surface cracking during cladding.

In an embodiment, microstructure observation refers to performing penetrant testing on the cladding layer of the cladding sample, observing whether there are no pores inside the cladding layer and whether it has been cladded. In an embodiment, if there are no pores inside the cladding layer and it has been cladded, it indicates that the procedure parameter model developed in the evaluation method meets the evaluation requirements, and the repaired part meets the usage requirements; otherwise, it does not meet the evaluation and usage requirements, and feedback is required to readjust the procedure parameter model. Furthermore, the microstructure observation also includes: by performing macroscopic metallographic analysis on the cladding layer, whether the overlap rate is greater than or equal to 40% is observed, for example, an overlap rate of 40%-50%; in an embodiment, if the overlap rate of the cladding layer is greater than or equal to 40% (e.g., overlap amount of 40%-50%), the powder meets the selection requirements; otherwise, it does not meet the selection requirements. In an embodiment, by performing penetrant testing on the cladding layer (powder after cladding), the powder with a large number of pores and incomplete cladding defect after cladding is screened out.

In an embodiment, the size of the cladding sample corresponding to the macroscopic observation and microstructure observation mentioned above is 40 mm×10 mm×10 mm. Macroscopic observation and microstructure observation, as well as metallographic analysis, are performed on the cladding sample to obtain a dilution rate of 1%-5% and an overlap rate of 40%-50% for the cladding layer 2 on the substrate 1 of the repaired part. There are no cracks, inclusions, or peeling of the cladding layer, which meets the evaluation requirements.

S221-2: hardness test.

In an embodiment, the hardness test refers to performing HV_{0.2} hardness test on both the cladding sample and substrate.

In an embodiment, if the HV_{0.2} hardness value of the cladding layer of the cladding sample is equivalent to that of the substrate, then the powder meets the selection requirements; otherwise, it does not meet the selection requirements.

In an embodiment, the HV_{0.2} hardness value of the cladding layer being equivalent to that of the substrate means that the difference between the two is within ±20 HV.

In an embodiment, the HV_{0.2} hardness test requires at least 9 measurement points.

In an embodiment, the HV_{0.2} hardness test method refers to the standard GB/T 4340.1-2009 Metallic Materials Vickers Hardness Test Part 1: Experiment Method to test the Vickers hardness of the cladding layer. Vickers hardness experiment requires that the upper and lower surfaces of the sample be smooth, flat, and parallel. The testing load is 200 g, and the load is held for 15 seconds. The testing direction is perpendicular to the surface of the cladding layer from the near surface of the cladding layer, with a spacing of no more than 0.2 mm between testing points. The testing points are distributed along the cladding layer, heat affected zone, and substrate direction in sequence.

In an embodiment, to investigate the compressive strength of the joint of laser cladding samples, hardness test is performed on the aforementioned cladding samples. In the above-mentioned hardness test, the cross-section of the substrate of the cladding sample needs to be polished to show the relative position between the cladding layer and the substrate, as well as the boundary between the heat affected zone. The size of the cladding sample is 40 mm×10 mm×10 mm. At least three testing points are sampled and tested in the cladding zone, heat affected zone, and substrate, with a total of no less than nine measurement points measuring a hardness value of HV₁₀ and an average hardness value of 260HV_{0.2}. If the final hardness value obtained from the hardness test is higher than that of the substrate, it proves that the hardness performance is good and the repaired part meets the requirements for use.

S221-3: tensile test.

In an embodiment, the tensile test refers to performing a tensile test on the cladding sample and substrate.

In an embodiment, if the tensile properties of the cladding layer of the cladding sample corresponding to the tensile sample approximate to those of the substrate, it proves that the mechanical properties of the laser cladding joint of the cladding sample are good, and the repaired part meets the requirements for use; otherwise, it does not meet the evaluation and usage requirements and feedback is required to readjust the procedure parameter model.

In an embodiment, the tensile properties of the cladding layer approximating to the substrate refers to that the difference in tensile strength between the two is within ±40 Mpa, and the difference in yield strength between the two is within ±30 Mpa.

In an embodiment, the distance Lc used for tensile test in the cladding samples corresponding to the above-mentioned cladding samples should be ≥3m. In the embodiment of the present invention, Lc=100 mm, the corresponding tensile strength of the cladding sample may reach 618 MPa, yield strength may reach 498 MPa, and elongation rate is 33.7%.

S221-4, impact test.

In an embodiment, the impact test refers to performing a −40° C. impact performance test on the cladding layer and the substrate.

In an embodiment, if the −40° C. impact performance of the cladding layer of the cladding sample corresponding to the impact test approximate to that of the substrate, it proves that the cladding joint of the cladding sample has good the low-temperature impact toughness, and the repaired part meets the requirements for use; otherwise, it does not meet the evaluation and usage requirements and feedback is required to readjust the procedure parameter model.

In an embodiment, whether the −40° C. impact performance of the cladding layer approximates to the substrate refers to that the difference in −40° C. impact absorption energy between the cladding layer and the substrate is within ±10 J.

In an embodiment, the above impact test is performed to evaluate the low-temperature toughness of the laser cladding joint of the cladding sample corresponding to the impact test. A cladding sample corresponding to the impact test includes the substrate and the cladding layer deposed on the substrate. The cladding sample adopts a V-shaped notch and is subjected to lateral impact during impact test. The impact energy of −40° C. KV2 is 82 J, which is higher than the 27 J impact energy requirement of substrate 1. The test results show that the cladding joint of the cladding sample has good low-temperature impact toughness.

S221-5: fretting friction wear test.

In an embodiment, the fretting friction wear test refers to performing fretting friction wear test on the cladding layer and the substrate.

In an embodiment, if the wear resistance of the cladding layer of the cladding sample corresponding to the fretting friction wear test approximates to that of the substrate, it proves that the cladding layer has good fretting wear performance, and the repaired part meets the requirements for use; otherwise, it does not meet the evaluation and usage requirements and feedback is required to readjust the procedure parameter model.

In an embodiment, the approximation in wear resistance between the cladding layer and the substrate refers to the difference in friction coefficient between the cladding layer and the substrate being within ±0.12.

In an embodiment, the above-mentioned fretting friction wear test is performed, and the corresponding cladding sample includes the substrate and the cladding layer disposed on the substrate. The size of the cladding sample is 20 mm×10 mm×8 mm. The fretting friction wear test is performed on a dedicated impact-shear composite fretting friction wear test bench, with stress loaded based on a vehicle operating load spectrum. The wear resistance of the cladding layer of the cladding sample corresponding to the fretting friction wear test approximates to that of the substrate, which proves that the cladding layer of the cladding sample has good fretting wear performance, and the repaired part meets the requirements for use.

S221-6: corrosion resistance test.

In an embodiment, the corrosion resistance test refers to performing salt spray corrosion and electrochemical corrosion on the cladding layer and the substrate.

In an embodiment, the salt spray corrosion refers to performing corrosion in salt spray of 3.5 wt. % NaCl solution, and inspecting the salt spray corrosion quality loss rates of both the cladding layer and the substrate.

In an embodiment, if the salt spray corrosion quality loss rate of the cladding layer approximates to that of the substrate, it proves that the cladding layer has good salt spray corrosion resistance and the repaired part meets the requirements for use; otherwise, it does not meet the evaluation and usage requirements and feedback is required to readjust the procedure parameter model. In an embodiment, approximation here refers to a mass loss rate between 250 g/m² and 300 g/m².

Furthermore, it also includes observing the surface shape after salt spray corrosion. If the number of corrosion pits on the surface of the cladding layer is less than that of the substrate, it proves that the cladding layer has good salt spray corrosion resistance and the repaired part meets the requirements for use; otherwise, it does not meet the evaluation and usage requirements and feedback is required to readjust the procedure parameter model.

In an embodiment, the salt spray corrosion time is greater than or equal to 100 hours, such as 100-480 hours.

In an embodiment, the salt spray corrosion test method is used for studying the corrosion resistance of the cladding layer by referring GB/T 10125-2021 Artificial Atmosphere Corrosion Experiment Salt Spray Test.

In an embodiment, the above-mentioned corrosion resistance test is performed. The corrosion resistance test is performed in a neutral salt spray environment, and at least five sets of cladding samples corresponding to the corrosion resistance test are selected. The size of the cladding sample is 50 mm×10 mm×8 mm. The test cycle for this corrosion resistance test is 240 hours. The test result of the corrosion resistance test in the embodiments of the present application shows that the salt spray corrosion resistance of the cladding layer of the cladding sample is higher than that of the substrate, proving that the cladding layer has good salt spray corrosion resistance and the repaired part meets the requirements for use.

In an embodiment, the electrochemical corrosion refers to inspecting the electrochemical corrosion performance and/or galvanic corrosion level of both the cladding layer and the substrate.

In some embodiments of the present application, the cladding sample is brought into contact with an electrolyte solution (3.5 wt % NaCl solution) to generate corrosion through electrode reaction. In an embodiment, the experiment is performed using an electrochemical workstation with a 3.5 wt % NaCl solution as the electrolyte. The cladding layer/substrate samples are connected to a reference electrode to form a circuit, and the corrosion performance is determined by collecting potential current curves and metal surface shape.

In an embodiment, if the electrochemical corrosion resistance of the cladding layer is higher than that of the substrate, and the galvanic corrosion level belongs to Class B, and it may be in contact under certain conditions, it proves that the cladding layer has good electrochemical corrosion resistance and the repaired part meets the requirements for use; otherwise, it does not meet the evaluation and usage requirements and feedback is required to readjust the procedure parameter model.

In an embodiment, the assessment criteria for galvanic corrosion level are based on the standard T/CSCP 0035.12-2007: Laboratory Corrosion Test of Low Alloy Structural Steel Part 12: Test Methods for galvanic Corrosion of Low Alloy Structural Steel.

In an embodiment, the performance test may be adjusted based on the different ultimate repair performance goals. For example, if the service environment of the substrate material is not severely corroded, the electrochemical corrosion test of the cladding sample may be omitted in this evaluation method.

S221-7: micro shear test.

In an embodiment, the micro shear test refers to investigating the metallurgical bonding capability between the cladding layer and the substrate.

In an embodiment, the micro shear test is performed on the cladding layer using a micro shear test machine, with a preferred shear speed of 1 mm/min to 2 mm/min and an optimal shear speed of 1.8 mm/min. The aim is to investigate whether the shear performance of the cladding layer metallurgically bonded with the substrate approximates to that of the substrate. If the shear performance value of the cladding layer is not less than that of the substrate, it proves that the cladding layer has high-strength metallurgical bonding capability with the substrate, and the repaired part meets the requirements for use; otherwise, it does not meet the evaluation and usage requirements and feedback is required to readjust the procedure parameter model.

In an embodiment, the above-mentioned micro shear test is performed to investigate the metallurgical bonding capability between the cladding layer and the substrate of the corresponding cladding sample. The cladding sample corresponding to the micro shear test includes the substrate and the cladding layer. The size of the cladding sample is 1.5 mm×1.5 mm×15 mm. The micro shear test is performed on the cladding sample on a micro shear test machine at a shear speed of 1 mm/min, and the shear performance of the cladding layer is tested to be 520 MPa. After comparison, the shear performance of the cladding sample is higher than that of the substrate, which fully proves that the cladding sample has high-strength metallurgical bonding capability with the substrate, and the repaired part may meet the requirements for use.

S221-8: bending performance test.

In an embodiment, the bending performance test refers to investigating the lateral bending performance of the cladding layer.

In an embodiment, the bending performance test is performed on the cladding layer using a bending testing machine. The experiment standards for bending performance test are based on GB/T 232-2010 Metallic Materials-Bending Test Method, with a test environment temperature of 23° C.±5° C. Whether there are cracks after side bending of the cladding layer is investigated. If there are no cracks of the cladding layer at 180° side bending, it proves that the cladding layer has good bending performance and the repaired part meets the requirements for use; otherwise, it does not meet the evaluation and usage requirements and feedback is required to readjust the procedure parameter model.

In an embodiment, the cladding samples corresponding to the bending performance test include the substrate and the cladding layer. The length of the cladding sample is 150 mm, and the bending performance test is performed in the form of side bending. Bending the cladding sample 180° without cracks proves that the bending performance of the cladding sample is good, and the repaired part may meet the requirements for use.

S221-9, fatigue test.

In an embodiment, the fatigue test refers to inspecting the fatigue performance of the cladding layer and/or the substrate.

In an embodiment, if 10⁷ fatigue performance of the cladding layer is not lower than that of the substrate, it proves that the cladding layer has good fatigue performance and the repaired part meets the requirements for use; otherwise, it does not meet the evaluation and usage requirements and feedback is required to readjust the procedure parameter model.

In an embodiment, the inspection method for fatigue performance refers to the standard GB/T 3075-2021 Metallic Materials Fatigue Test Axial Force Control Method. In some embodiments of the present application, a QBG-100 high-frequency fatigue test machine is used to perform fatigue tests on substrate samples made of G20Mn5 QT and cladding samples under a normal temperature and pressure environment using experiment parameters with a stress ratio of 0 and a vibration frequency of 80-100 Hz.

In an embodiment, the evaluation method described in the present application is applied to the repair process evaluation and quality qualification of cast steel axle box bodies, where the material of the axle box body is made of G20Mn5 QT.

In the present application, the meaning of the substrate is the same as that of the matrix, for example, both are cast steel axle box bodies.

Referring to the qualification test described in step S22 above, the cladding sample is made based on the process described in S22 above.

In an embodiment, the sizes of the cladding samples corresponding to point defect and line defect are determined based on the depth of the defect as follows: the thickness of the matrix t is ≥ 12 mm, the overall size of the matrix is 350 mm×300 mm, and the thickness of the cladding layer is less than or equal to 1 mm.

In an embodiment, the sizes of the matrix corresponding to the surface defect in the cladding sample are as follows: the thickness of the matrix t is ≥12 mm, and the overall size of the matrix is 350 mm×300 mm. The thickness of the single-layer cladding layer on the matrix is less than or equal to 1 mm. There are a total of three single-layer cladding layers, and the width of the cladding layer m is ≥30 mm.

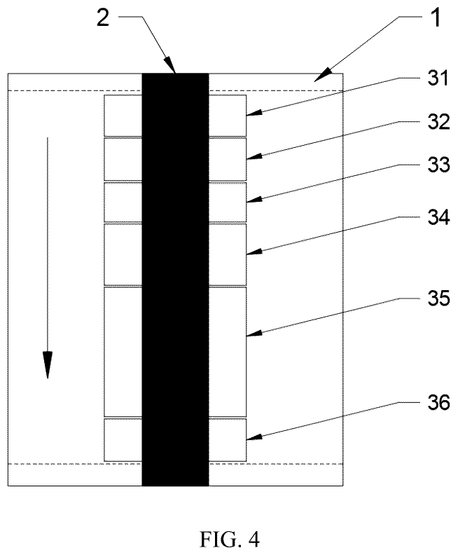

The sampling rules for the cladding samples corresponding to surface defect are determined based on numerical simulation analysis of the internal temperature and stress fields of the cladding samples. This is because: laser cladding heating gradually stabilizes the cladding performance and it is crucial to investigate the fretting wear performance, macroscopic and microstructure, and dilution rate of the cladding layer in the initial stage of laser cladding process. Therefore, the sampling rules for cladding samples corresponding to surface defect are determined as follows: preparing and obtaining the corresponding cladding samples for the above qualification test from the starting point of laser cladding along the cladding direction, as indicated by the arrows in FIG. 4.

As shown in FIG. 4, from the starting point of the cladding layer 2 at the surface defect, a first sampling area 31, a second sampling area 32, a third sampling area 33, a fourth sampling area 34, a fifth sampling area 35, and a sixth sampling area 36 are sequentially obtained along the cladding direction. Sampling is performed in the first sampling area 31 to prepare the cladding sample corresponding to the fretting friction wear test; sampling is performed in the second sampling area 32 to prepare the cladding sample corresponding to macroscopic observation and microstructure observation, as well as the cladding sample corresponding to hardness test; sampling is performed in the third sampling area 33 to prepare the first cladding sample corresponding to the tensile test; sampling is performed in the fourth sampling area 34 to prepare the cladding sample corresponding to impact test; sampling is performed the fifth sampling area 35 to prepare a cladding sample corresponding to the corrosion resistance test; and sampling is performed in the sixth sampling area 36 to prepare a cladding sample corresponding to the second tensile test.

In an embodiment, to complete other relevant testing in the above qualification test, based on the above sampling rules, it is preferred to further sample in the third sampling area 33 to prepare a cladding sample corresponding to the bending performance test, in the fifth sampling area 35 mentioned above to prepare the cladding samples corresponding to the micro shear test, in the sixth sampling area 36 mentioned above to prepare the cladding sample corresponding to the second bending performance test.

In the embodiments of the present application, to ensure the quality of laser cladding, the surface of the to-be-repaired part needs to be simulated for the daily cladding qualification test before performing the laser cladding repair procedure. The qualification test uses 150 mm×150 mm×10 mm samples to prepare a planar repair groove for cladding. The cladding layer is shown in FIG. 6. Process parameters of laser cladding repair procedure include that: the laser power is 2300 W, the diameter of the laser spot is 5 mm, the distance between a nozzle and the surface of the groove is 11.6 mm, the scanning speed is 8 mm/s, the powder feeding rate is 8 g/min, the powder feeding gas flow rate is 7 L/min, and the overlap rate is 40%, and the cladding quality is shown in FIG. 7.

After the cladding is completed, the appearance observation and penetrant inspection is performed on the sample. After the sample is qualified, sampling is performed to inspect whether the internal cladding quality and dilution rate of the cladding sample meet the requirements. After the sample is qualified, the part cladding is performed.

In the embodiments of the present application, the step S3 of performing, based on a result of the procedure optimization and the procedure qualification, laser cladding repair procedure on a defect location to form a cladding layer on the groove further includes:
S31: making, based on the result of the procedure optimization and the procedure qualification, a laser cladding procedure regulation for the part, and determining optimal procedure parameters for the laser cladding repair procedure; and
S32. performing laser cladding repair on the groove using the optimal procedure parameters based on the laser cladding procedure regulation and the cladding parameter corresponding to the defect characteristic.

By the step of performing, based on the result of the procedure optimization and the procedure qualification, laser cladding repair procedure on the defect location to form the cladding layer on the groove, a laser cladding procedure parameter calculation model may be built, which may set laser cladding procedure parameter at low cost and quickly, improve parameter accuracy, ensure laser cladding quality, and improve laser cladding efficiency.

In an embodiment, the optimal procedure parameters for the laser cladding repair procedure mentioned above include that: the laser power ranges from 2000 watts to 3000 watts, the diameter of the laser spot is 4 millimeters to 6 millimeters, the distance between a nozzle and the surface of the groove is 8 millimeters to 12 millimeters, the scanning speed is 6 millimeters to 10 millimeters per second, the powder feeding rate is 5 grams per minute to 12 grams per minute, the powder feeding gas flow rate is 6 liters per minute to 8 liters per minute (most preferably 7 liters per minute), the protective gas flow rate is 30 liters per minute to 40 liters per minute, and the overlap rate is 40% to 50% (most preferably 45%).

The method for determining the optimal procedure parameters is the same as the previous, and will not be repeated here.

In the embodiments of the present application, after the step S3 of performing laser cladding repair on the groove, the repair method further includes a cladding layer inspection. The cladding layer inspection includes: selecting several detection positions at the cladding layer for subtractive processing, where the substrate being not exposed at a subtractive-processed detection position is taken as being qualified, and an amount of subtractive processing at the detection position is not less than 0.5 millimeters.

In the embodiments of the present application, the daily cladding qualification test is completed and the apparatus cladding quality is verified to meet the repair requirements. After the qualification test passes, the laser cladding repair procedure for the axle box body will begin. The regulation for the laser cladding repair procedure is: selecting different standardized cladding repair procedures based on the above defect characteristics. In an embodiment, the laser cladding procedure regulations are made based on the result of procedure optimization and procedure qualification, and the process flow of laser cladding repair procedure is developed. The laser cladding procedure regulations are made for determining whether the repaired parts meet the quality evaluation criteria. Quality evaluation is the evaluation of products made based on the procedure regulation. The quality evaluation will be described in detail later and will not be repeated here.

The laser cladding repair procedure described in the embodiments of the present application is preferably implemented through a laser cladding robot system. The laser cladding robot system may inspect the working conditions of the cladding area of the axle box body, make the cladding process, complete the cladding of the axle box body and the inspection of the amount of subtractive processing for cladding layers of 0.5 mm or more, achieve cladding repair of defects in different parts of the axle box body, and achieve good deformation control.

In the embodiments of the present application, after the step S3 of performing laser cladding repair on the groove, the repair method further includes stress relief treatment. Stress relief treatment includes: performing stress relief on the repaired cladding layer through ultrasonic vibration impact, where a residual stress of the stress-relieved cladding layer is not higher than 159 megapascals.

In an embodiment, after the laser cladding repair procedure is completely performed on the axle box body, stress relief treatment is performed using ultrasonic vibration impact. The maximum residual stress after treatment is 159 MPa, which is much lower than the yield strength of the material. The effect of laser cladding on the structural properties of the axle box body is reduced by reducing the surface residual stress.

In the embodiments of the present application, the step S4 of performing quality evaluation on the cladding layer further includes:

S41: performing quality evaluation on the cladding layer based on operating environment and working condition of the part after performing laser cladding repair procedure on the defect location.

In an embodiment, the step of performing quality evaluation on the cladding layer described in the embodiments of the present application is to ensure the repair quality of the repaired layer of the cast steel axle box body. The quality evaluation process requires test of the quality status of the repaired part through dimensional measurement and penetrant testing to ensure that the quality of the axle box body cladding repair meets the requirements.

In the embodiments of the present application, a laser cladding procedure regulation is made for the laser cladding repair procedure to improve the accuracy and reliability of laser cladding repair, enhance the efficiency and control accuracy of the entire processes and quality control, effectively improve the size recovery and performance maintenance of parts such as axle box bodies, and achieve the feasibility of cyclic installation and use through axle box repair.

In an embodiment, the laser cladding procedure regulation for the part includes the procedure qualification and quality evaluation requirements mentioned above. The requirements for quality evaluation are described in Table 1.

In an embodiment, items of the quality evaluation include surface inspection, at least two non-destructive testing, dimensional check, processing inspection, fatigue test, and trial operation investigation.

TABLE 1
Quality Evaluation Requirements for Laser
Cladding Repaired Parts of Axle Box Bodies

| Serial | | | |
|---|---|---|---|
| number | Evaluation item | Evaluation criterion | Evaluation method |
| 1 | Surface inspection | The surface of the laser cladding | Visual inspection |
| | | repaired layer has no cracks, pores, | |
| | | or defect such as poor layer overlap | |
| 2 | Non-destructive | Laser cladding repaired layer | Penetrant testing |
| | testing | surface has no cracks | |
| 3 | Dimensional check | The size meets the design | Size inspection by |
| | | requirements for part dimensions | coordinate measuring |
| | | | machine |
| 4 | Processing | Inspect that there are no cracks, | visual observation |
| | inspection | pores, or incomplete cladding defect | and penetrant testing |
| | | on the surface of the laser cladding | for a surface |
| | | repaired layer after processing | |
| 5 | Fatigue test | whether the vibration fatigue | vibration fatigue for |
| | | performance meets the requirements | 10 million cycles |
| | | and compare the performance with | |
| | | the test data of the newly | |
| | | manufactured axle box body | |
| 6 | Non-destructive | No cracks on the surface | Penetrant testing |
| | testing | | |
| 7 | Trial-operation | After one investigation test cycle, | Surface inspection |
| | investigation | inspect no cracks on the surface of | after installation |
| | | the axle box body | verification for 480- |
| | | | thousand kilometers |

In the embodiments of the present application, the process of evaluating the quality of the repaired axle box body is as follows: firstly, visual inspection is used to inspect no defects such as cracks, pores, and poor layer pass overlap occurs on the surface of the laser cladding repaired layer and a 20-50× magnifying glass may be used for observation. The penetrant testing method is used to inspect no cracks, pores, and incomplete cladding defect on the surface of the laser cladding repaired layer. After the test of the repaired layer of the cast steel axle box body, surface processing treatment is carried out on the repaired layer. After processing, a three-coordinate dimension inspector is used for dimension check to ensure that the repaired axle box body meets the structural dimension requirements; after completing the processing, performing visual observation and penetrant testing on the surface of the repaired layer again to check that there are no cracks, pores, or incomplete cladding defect on the surface of the laser cladding repaired layer; after passing the surface penetrant testing, performing structural fatigue tests on the axle box body repaired by laser cladding to verify whether the vibration fatigue performance meets the requirements after 10 million cycles; after completing 10 million cycles of vibration fatigue, a comprehensive surface visual observation and penetrant testing is performed on the repaired axle box body. If there are no cracks on the surface, the part is qualified; after passing the above tests, the laser cladding repaired axle box body will be subjected to installing and trial-operation investigation. After one investigation test cycle (480 thousand kilometers), the condition of the axle box body is checked. If there are no problems, it may be installed and applied to the vehicle in bulk.

In the embodiments of the present application, the repair method further includes performing post-processing on the part in step S5. As shown in FIG. 2, performing post-processing on the part includes:

S51: machining a part passing the quality evaluation based on a requirement for part usage; and

S52: performing pre-installation inspection to the machined part. if the pre-installation inspection passes, performing installing and trial usage and completing quality inspection of the part; and if the pre-installation inspection fails, scrapping the part.

In an embodiment, in step S51, after the repaired axle box body passes the quality evaluation, precision CNC machining technology is used to restore the structural dimensions and surface roughness of the axle box body based on the technical requirements of the design drawings, to meet the usage requirements of the axle box body.

In an embodiment, in step S52 above, to ensure that the quality of the repaired axle box body meets the requirements for be installed and used, the processed axle box body is subjected to dimensional detection and penetrant test. After the inspection passes, it may be installed for operation, and the quality of the repaired axle box body is inspected. If the inspection fails, the repaired axle box body will be scrapped.

The embodiments of the present application further provide a laser cladding repair apparatus for surface damage of part, which may perform the laser cladding repair method for surface damage of part as described above. The laser cladding apparatus for surface damage of the part includes cladding material preparation system, groove preparation system, procedure optimization and qualification system, laser cladding repair system, and quality evaluation system, which are connected with each other.

In an embodiment, the cladding material preparation system is used for preparing a cladding material for repair.

In an embodiment, the groove preparation system is used for preparing a groove.

In an embodiment, the procedure optimization and qualification system is used for performing procedure optimization and procedure qualification.

In an embodiment, the laser cladding repair system is used for performing laser cladding repair procedure at the defect location.

In an embodiment, the quality evaluation system is used for performing quality evaluation on the cladding layer.

The apparatus is provided with the above-mentioned cladding material preparation system, groove preparation system, procedure optimization and qualification system, laser cladding repair system, and quality evaluation system, which enable the apparatus to have all the advantages of the laser cladding repair method for surface damage of part.

The embodiments of the present application further provide a part repaired by laser cladding, where the part is obtained by performing the laser cladding repair method for surface damage of part as described above; alternatively, the part may be generated using the laser cladding apparatus for surface damage of part as described above.

As shown in FIG. 5 and FIG. 6, the surface damage location of the part is filled with at least one cladding layer, and each cladding layer is at least partially overlapped with a previous cladding layer. Each cladding pass within the same cladding layer overlaps at least partially with a previous cladding pass. Such as single-layer cladding (as shown in FIG. 5), double-layer cladding (as shown in FIG. 6), or multi-layer cladding (not shown in the attached figure) as described above. The preferred single-layer thickness for the cladding layer is about 1 mm, with an overlap of about 40% and a defect depth of less than 1 mm. One layer of cladding is preferably chosen. If the defect depth exceeds 1 mm, two layers of cladding is preferably chosen. The laser cladding process and quality evaluation of the repair layer for this part are based on the above and will not be repeated here.

The parts repaired by the above method or apparatus have good metallurgical bonding between the repaired cladding layer and the substrate, with small deformation and high repair accuracy. This may improve the dimensional recovery of the repaired parts compared to the original undamaged parts, which is beneficial for improving the assembly accuracy of subsequent parts, repeatedly installing and using the service axle box body, prolonging the service life of parts such as the axle box body, and reducing device maintenance costs.

In the description of the embodiments of the present application, it should be noted that, the orientation or positional relations specified by terms such as “central”, “longitudinal”, “lateral”, “up”, “down”, “front”, “back”, “left”, “right”, “vertical”, “horizontal”, “top”, “bottom”, “inner”, “outer” and the like, are based on the orientation or positional relations shown in the drawings, which is merely for convenience of description of the present application and to simplify description, but does not indicate or imply that the stated devices or components must have a particular orientation and be constructed and operated in a particular orientation, and thus it is not to be construed as limiting the present application. Furthermore, the terms “first”, “second”, “third” and the like are only used for descriptive purposes and should not be construed as indicating or implying a relative importance.

In the description of the embodiments of the present application, it should be noted that unless explicitly specified and defined otherwise, the terms “connected to” and “connected” shall be understood broadly, for example, it may be either fixedly connected or detachably connected, or can be integrated; it may be either mechanically connected, or electrically connected; it may be either directly connected, or indirectly connected through an intermediate medium. The specific meanings of the terms above in the present application can be understood by those skilled in the art in accordance with specific conditions.

In the embodiments of the present application, unless otherwise expressly specified and defined, a first feature is “on” or “under” a second feature can refer to that the first feature is directly contacted with the second feature, or the first feature is indirectly contacted with the second feature through an intermediate medium. In addition, the first feature is “on”, “above” and “over” the second feature can refer to that the first feature is directly above or obliquely above the second feature, or simply refer to that the level height of the first feature is higher than that of the second feature. A first feature is “under”, “below” and “beneath” a second feature can refer to that the first feature is directly below or obliquely below the second feature, or simply refer to that the level height of the first feature is lower than that of the second feature.

In the description of the present specification, description with reference to the terms “an embodiment”, “some embodiments”, “an example”, “specific example”, “some examples” and the like, refers to that specific features, structures, materials or characteristics described in combination with an embodiment or an example are included in at least an embodiment or example according to the embodiments of the present application. In this specification, schematic representations of the above terms are not necessarily directed to a same embodiment or example. Furthermore, the particular features, structures, materials or characteristics described can be combined in any suitable manner in any one or more embodiments or examples. In addition, those skilled in the art may combine the different embodiments or examples described in this specification, as well as the features of the different embodiments or examples, without conflicting each other.

It should be noted that the above embodiments are only used to explain the solutions of the present application, and are not limited thereto; although the present application has been described in detail with reference to the foregoing embodiments, it should be understood by those skilled in the art that modifications to the technical solutions documented in the foregoing embodiments and equivalent substitutions to a part of the features can be made and these modifications and substitutions do not make the essence of the corresponding solutions depart from the scope of the solutions of various embodiments of the present application.

What is claimed is:

1. A laser cladding repair method for surface damage of part, comprising:
preparing a cladding material for repair, and preparing a groove based on a defect characteristic of a to-be-repaired part obtained from inspection and assessment;
performing procedure optimization and procedure qualification;
performing, based on a result of the procedure optimization and the procedure qualification, laser cladding repair procedure on a defect location to form a cladding layer on the groove; and
performing quality evaluation on the cladding layer.

2. The method of claim 1, wherein in the result of the procedure optimization and the procedure qualification, a procedure parameter of the laser cladding repair procedure comprises: a spot diameter of a laser thermal source is greater than or equal to 3 millimeters and less than or equal to 6 millimeters.

3. The method of claim 1, wherein preparing the cladding material for repair comprises:
selecting powder preliminarily to produce the cladding material, wherein the selecting powder preliminarily is based on a principle of processability and an approximation principle of physical properties,
wherein the principle of processability comprises: investigating self-solubility, wettability, and crack resistance of to-be-selected powder; and
the approximation principle of physical properties comprises: investigating that a coefficient of thermal expansion and a melting point of the to-be-selected powder approximate to a coefficient of thermal expansion and a melting point of a substrate.

4. The method of claim 1, wherein preparing the groove based on the defect characteristic of the to-be-repaired part obtained from inspection and assessment comprises:
determining the defect characteristic of the to-be-repaired part;
determining groove forms and a processing parameter for the groove based on the defect characteristic; and
preparing the groove based on the processing parameter.

5. The method of claim 4, wherein determining the defect characteristic of the to-be-repaired part comprises:
pre-building a three-dimensional model of a part as a standard reference group;
inspecting and obtaining a scanning model of the to-be-repaired part; and
comparing the scanning model with the standard reference group to obtain the defect characteristic of the defect location of the to-be-repaired part.

6. The method of claim 4, wherein the defect characteristics comprise defect types and a defect size,
wherein the defect types comprise a point defect, a scratch defect, a curved surface defect, a flat surface defect, and a part edge defect; and
the groove forms comprise a point cladding groove, a line cladding groove, a curved surface cladding groove, a flat surface cladding groove, and a part edge groove.

7. The method of claim 1, wherein performing the procedure optimization and the procedure qualification comprises:
building, based on the defect characteristic and performance of the cladding material, a repair procedure parameter model to perform the procedure optimization and sample preparation;
performing corresponding qualification tests on various types of cladding samples obtained from the sample preparation to obtain a result of the procedure qualification;
providing feedback and modifying the procedure optimization based on the result of the procedure qualification,
wherein the procedure optimization comprises determining an optimal procedure parameter based on the procedure parameter of the repair procedure parameter model during laser cladding repair, through an orthogonal coupling experiment in combination with a range analysis;
the procedure parameters of the repair procedure parameter model comprise a laser power, a scanning speed, a powder feeding rate, and a diameter of a laser spot; and
the qualification test comprises macroscopic observation and microstructure observation, as well as fretting friction wear test, and investigating a dilution rate of the cladding layer of the cladding sample.

8. The method of claim 7, wherein building, based on the defect characteristic and performance of the cladding material, the repair procedure parameter model comprises:
determining to-be-repaired morphology parameters of the to-be-repaired part based on the defect characteristic, and building the repair procedure parameter model, wherein the to-be-repaired morphology parameters comprise a cladding width, a cladding height, and a dilution rate; and
setting the procedure parameter for the laser cladding repair procedure based on the repair procedure parameter model and the to-be-repaired morphology parameters.

9. The method of claim 8, wherein determining the to-be-repaired morphology parameters of the to-be-repaired part based on the defect characteristic, and building the repair procedure parameter model comprises:
selecting, in sequence, one of the procedure parameters of the laser cladding repair procedure as an only test variable parameter, and performing a single-pass cladding layer single-factor test;
obtaining a set of cladding quality parameters for a single-pass cladding layer, wherein the cladding quality parameters comprise the cladding width, the cladding height, and the dilution rate; and
building the repair procedure parameter model based on the set of cladding quality parameters.

10. The method of claim 8, wherein the repair procedure parameter model is:
$$D = 0.8 \times {X}^{- 2} \times {K}^{1.8} + 0.9 \times ( 3.5 - R ) ;$$
$$H = 0.4 \times ( {X}^{- 0.9} ) \times {K}^{0.4} + 0.2 \times ( 3.5 - R ) ; and$$
$$W = 2.2 \times ( {X}^{- 0.5} ) \times {K}^{0.4} - 0.4 \times ( 3.5 - R ) ,$$
wherein D is the dilution rate; H is the cladding height; W is the cladding width; X is a powder feeding rate; K is a laser energy density, K=P/V, P is the laser power, and V is the scanning speed; and R is the diameter of the laser spot.

11. The method of claim 7, wherein the qualification tests further comprise at least one of hardness test, tensile test, impact test, corrosion resistance test, micro shear test, bending performance test, and fatigue test.

12. The method of claim 7, wherein
before preparing the groove, the method further comprises defect removal; and/or,
before the qualification test, and/or after performing the laser cladding repair procedure, the laser cladding repair method for surface damage of part further comprises non-destructive testing, wherein the non-destructive testing comprises penetrant testing and X-ray testing.

13. The method of claim 1, wherein performing, based on the result of the procedure optimization and the procedure qualification, laser cladding repair procedure at the defect location to form the cladding layer on the groove comprises:
making, based on the result of the procedure optimization and the procedure qualification, a laser cladding procedure regulation for the part, and determining an optimal procedure parameter for the laser cladding repair procedure; and
performing laser cladding repair on the groove using the optimal procedure parameter based on the laser cladding procedure regulation and the cladding parameter corresponding to the defect characteristic.

14. The method of claim 13, wherein the optimal procedure parameters comprise: the laser power ranging from 2000 watts to 3000 watts, the diameter of the laser spot being 4 millimeters to 6 millimeters, a nozzle distance being 8 millimeters to 12 millimeters, the scanning speed being 6 millimeters/second to 10 millimeters/second, the powder feeding rate being 5 grams/minute to 12 grams/minute, a powder feeding gas flow rate being 6 liters/minute to 8 liters/minute, a protective gas flow rate being 30 liters/minute to 40 liters/minute, and an overlap rate being 40% to 50%.

15. The method of claim 13, wherein after performing laser cladding repair on the groove, the method further comprises cladding layer inspection and stress relief treatment,
wherein the cladding layer inspection comprises:
selecting several detection positions at the cladding layer for subtractive processing, wherein the substrate being not exposed at a subtractive-processed detection position is taken as be qualified,
wherein an amount of subtractive processing at the detection position is not less than 0.5 millimeters; and
the stress relief treatment comprises:
performing stress relief on the repaired cladding layer through ultrasonic vibration impact,
wherein a residual stress of the stress-relieved cladding layer is not higher than 159 megapascals.

16. The method of claim 1, wherein performing quality evaluation on the cladding layer comprises:
performing quality evaluation on the cladding layer based on operating environment and working condition of the part after performing laser cladding repair procedure on the defect location,
wherein items of the quality evaluation comprise surface inspection, at least two non-destructive testing, dimensional check, processing inspection, fatigue test, and trial operation investigation.

17. The method of claim 1, further comprising performing post-processing on the part,
wherein performing the post-processing on the part comprises:
machining a part passing the quality evaluation result based on a requirement for part usage;
performing pre-installation inspection on the machined part; and
if the pre-installation inspection is qualified, performing installing and trial usage and completing quality inspection of the part; or
if the pre-installation inspection fails, scrapping the part.

18. A laser cladding repair apparatus for surface damage of part, wherein the laser cladding apparatus performs the laser cladding repair method for surface damage of part of claim 1, wherein the apparatus comprises a cladding material preparation system, a groove preparation system, a procedure optimization and qualification system, a laser cladding repair system, and a quality evaluation system connected to each other,
wherein the cladding material preparation system is used for preparing a cladding material for repair;
the groove preparation system is used for preparing a groove;
the procedure optimization and qualification system is used for performing procedure optimization and procedure qualification;
the laser cladding repair system is used for performing laser cladding repair procedure at the defect location; and
the quality evaluation system is used for performing quality evaluation on the cladding layer.

19. A part repaired by laser cladding, wherein the part is obtained by performing the laser cladding repair method for surface damage of part of claim 1;
the surface damage location of the part is filled with at least one cladding layer, and each cladding layer is at least partially overlapped with a previous cladding layer; each cladding pass within the same cladding layer at least partially overlaps with a previous cladding pass.

20. A part repaired by laser cladding, wherein the part is generated using the laser cladding apparatus for surface damage of part of claim 18;
the surface damage location of the part is filled with at least one cladding layer, and each cladding layer is at least partially overlapped with a previous cladding layer; each cladding pass within the same cladding layer at least partially overlaps with a previous cladding pass.
